(19) United States
(12) Patent Application Publication
(10) Pub. No.: US 2023/0151176 A1
(43) Pub. Date: May 18, 2023

(54) BLOWING AGENTS FOR EXTRUDED POLYSTYRENE FOAM AND EXTRUDED POLYSTYRENE FOAM AND METHODS OF FOAMING

(71) Applicant: HONEYWELL INTERNATIONAL INC., Charlotte, NC (US)

(72) Inventors: Josep GIMENO, Charlotte, NC (US); Ryan HULSE, Charlotte, NC (US); Syed Hassan MAHMOOD, Charlotte, NC (US)

(73) Assignee: HONEYWELL INTERNATIONAL INC., Charlotte, NC (US)

(21) Appl. No.: 17/988,631

(22) Filed: Nov. 16, 2022

Related U.S. Application Data
(60) Provisional application No. 63/279,909, filed on Nov. 16, 2021.

(51) Int. Cl. C08J 9/14

(52) U.S. Cl. CPC C08J 9/149; C08J 2203/182; C08J 2325/06

(57) ABSTRACT

Methods, foams and blowing agents for forming for forming extruded polystyrene foam wherein the blowing agent comprises (i) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these; and (ii) from about 30% to about 60% by weight of isobutane, methyl formate and combinations of these.

### CROSS REFERENCE TO RELATED APPLICATIONS

This patent application claims the priority benefit of U.S. Provisional Application No. 63/279,909, filed Nov. 16, 2021, which is incorporated herein by reference in its entirety.

This patent application also relates to and claims the priority benefit of U.S. application Ser. No. 17/527,787, filed on Nov. 16, 2021, which in turn claim the priority benefit of Provisional Application No. 63/114,948, filed Nov. 17, 2020 and U.S. Provisional Application No. 63/181,135, filed Apr. 28, 2021, each of which is incorporated herein by reference in its entirety.

### FIELD OF THE INVENTION

This invention relates to compositions, methods and systems having utility in connection with extruded thermoplastic foams, including particularly in connection with blowing agents, foamable compositions, foams and articles made with or from polystyrene foams.

### BACKGROUND

Certain fluorocarbon fluids have found widespread use as blowing agents. Because of environmental problems, including relatively high ozone depletion potentials, associated with the use of some of the fluorocarbon fluids that have heretofore been used in these applications, it has become increasingly desirable to use fluids having low or even zero ozone depletion potential, such as hydrofluorocarbons (“HFCs”). However, some HFC fluids may have relatively high global warming potentials associated therewith, and it is desirable to use hydrofluorocarbon or other fluorinated fluids having low ozone depletion potential and low global warming potential while maintaining the desired performance properties of the foam.

In terms of performance properties of the foam, it is considered important in many cases that the foam possess excellent thermal insulating properties and other desirable foam characteristics. Another foam characteristic that is important in many applications is the density of the foam. For example, there is a need in many thermal insulating foam applications to have a foam that not only exhibits a low thermal conductivity, but also a relatively low foam density.

A significant challenge has been encountered in efforts to achieve thermoplastic foams that at once have low thermal conductivity (measured after ageing) and low density, and in particular to the achievement of thermoplastic polystyrene foam with a density of less than 32 kg/m³ and at the same time an low thermal conductivity. For example, EP 2706086 includes numerous examples of polystyrene foam made using a variety of different blowing agent compositions, including blowing agents comprised of HFO-1234ze and one or more coblowing agents. However, not a single example which used HFO blowing agent was able to achieve a density of less than 34.6 kg/m³, and even the foam made from a blowing agent comprising ethanol and CO2 blowing agent had a density above 32 kg/m³ and a relatively high thermal conductivity of 34.7 mW/mK. Similarly, while each of US2019/0211172, US 2018/0327565, WO/2020/041539 and WO/2020/018332 disclose polystyrene foams made from various blowing agent compositions, none of these publications disclose a foam that has a density of less than 32 kg/m3 and at the same time a low thermal conductivity.

Similarly, while JP2021/10388313 indicates that it has as an objection the achievement of foams with good insulating properties using blowing agents comprising HFO-1224yd, there is no disclosure of a specific example that at once achieves a density of less than 32 kg/m³ and a low thermal conductivity. In particular, Examples A1 through A15 of JP2021/10388313 suggest that low thermal conductivity foams made from several thermoplastic materials can be formed from blowing agent comprising HFO-1224yd. However, JP2021/10388313 discloses that relatively high (and undesirable) foaming agent loadings are used to produce the foam, and does not disclose that any of the polystyrene foams in these examples was able to achieve a density of less than 32 kg/m³ while at the same time achieving a desirably low thermal conductivity.

There has thus been an increasing need for new blowing agent materials that are attractive alternatives to the compositions heretofore used as blowing agents in these and other applications. Applicants have thus recognized a need for new blowing agent compositions that offer effective alternatives to, and are considered environmentally safer substitutes for, previously used blowing agents to make low density, low thermal conductivity thermoplastic foams, and extruded polystyrene foam in particular.

The use of halogenated olefin blowing agents, including hydrofluoroolefins (HFOs) and hydrochlorofluorolefins (HCFOs), is also known, as disclosed for example in US 2009/0305876, which is assigned to the assignee of the present invention and which is incorporated herein by reference.

Notwithstanding the disclosures in each of the '876, applicants have come to appreciate that an unexpected advantage can be achieved in connection with the formation of extruded thermoplastic foams, and in particular extruded polystyrene foams, by using a hydrofluoroolefin, particularly one or more HFOs and/or HFCOs having three or four carbons, such as trans-HCFO-1233zd, cisHFO-1224yd and cis-1,1,1,4,4,4-hexafluorobut-2-ene (HFO-1336mzz(Z)), in combination with at least one carefully selected blowing agent in carefully selected amounts, as explained in detail hereinafter.

### SUMMARY

The present invention includes blowing agents for producing thermoplastic foams with excellent thermal insulating properties (including preferably low aged lambda) and low foam density, said blowing agent comprising:

(a) from about 40% by weight to about 70% by weight of one or more HFOs having three or four carbon atoms and/or an HFCOs having three or four carbon atoms being selected from the group consisting of 1224yd(Z), 1233zd(E), 1336mzz(Z) and combinations of these; and

(b) from about 30% to about 60% by weight of isobutane, dimethyl ether, methyl formate, ethanol and combinations of these, provided that the amount of (a) and (b) in the blowing agent is not less than about 90% by weight. For the purposes of convenience, blowing agents in accordance with this paragraph are referred to herein as Blowing Agent 1A.

The present invention includes blowing agents for producing thermoplastic foams with excellent thermal insulating properties (including preferably low aged lambda) and low foam density, said blowing agent comprising:

(a) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 30% to about 60% by weight of isobutane, dimethyl ether methyl formate, ethanol and combinations of these, provided that the amount of (a) and (b) in the blowing agent is not less than about 95% by weight. For the purposes of convenience, blowing agents in accordance with this paragraph are referred to herein as Blowing Agent 1B.

The present invention includes blowing agents for producing thermoplastic foams with excellent thermal insulating properties (including preferably low aged lambda) and low foam density, said blowing agent comprising:

(a) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 30% to about 60% by weight of isobutane, dimethyl ether methyl formate, ethanol and combinations of these, provided that that the amount of (a) and (b) in the blowing agent is not less than about 97% by weight. For the purposes of convenience, blowing agents in accordance with this paragraph are referred to herein as Blowing Agent 1C.

The present invention includes blowing agents for producing thermoplastic foams with excellent thermal insulating properties (including preferably low aged lambda) and low foam density, said blowing agent consisting essentially of:

(a) from about 45% by weight to about 60% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 40% to about 55% by weight of isobutane, dimethyl ether, methyl formate and combinations of these, provided that said isobutane is present in the blowing agent in an amount of at least about 25% by weight. For the purposes of convenience, blowing agents in accordance with this paragraph are referred to herein as Blowing Agent 1D.

The present invention includes blowing agents for producing thermoplastic foams with excellent thermal insulating properties (including preferably low aged lambda) and low foam density, said blowing agent consisting essentially of:

(a) from about 45% by weight to about 60% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 30% to about 55% by weight of isobutane, dimethyl ether, methyl formate and combinations of these, provided that said isobutane is present in the blowing agent in an amount of at least about 30% by weight. For the purposes of convenience, blowing agents in accordance with this paragraph are referred to herein as Blowing Agent 1E.

The present invention includes blowing agents for producing thermoplastic foams with excellent thermal insulating properties (including preferably low aged lambda) and low foam density, said blowing agent consisting essentially of:

(a) from about 45% by weight to about 60% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 40% to about 55% by weight of isobutane, dimethyl ether, methyl formate and combinations of these, provided that said isobutane is present in the blowing agent in an amount of at least about 30% by weight. For the purposes of convenience, blowing agents in accordance with this paragraph are referred to herein as Blowing Agent 1F.

The present invention includes blowing agents for producing thermoplastic foams with excellent thermal insulating properties (including preferably low aged lambda) and low foam density, said blowing agent consisting essentially of:

(a) from about 25% by weight to about 55% by weight of one or more of 1233zd(E), 1224yd(Z), 1336mzz(Z) and combinations of these; and

(b) from about 25% to about 75% by weight of isobutane, dimethyl ether, methyl formate, ethanol and combinations of these, provided that said methyl formate when present is present in an amount of less than about 15%; and

(c) from about 3% to about 32% by weight of CO₂. For the purposes of convenience, blowing agents in accordance with this paragraph are referred to herein as Blowing Agent 1G.

The present invention includes blowing agents for producing thermoplastic foams with excellent thermal insulating properties (including preferably low aged lambda) and low foam density, said blowing agent consisting essentially of:

(a) from about 45% by weight to about 55% by weight of one or more of 1233zd(E), 1224yd(Z), 1336mzz(M) and combinations of these; and

(b) from about 45% to about 55% by weight of isobutane, dimethyl ether, methyl formate and combinations of these, provided that said methyl formate when present is present in an amount of less than about 15%; and

(c) about 3% by weight of CO₂. For the purposes of convenience, blowing agents in accordance with this paragraph are referred to herein as Blowing Agent 1H.

The present invention includes blowing agents for producing thermoplastic foams with excellent thermal insulating properties (including preferably low aged lambda) and low foam density, said blowing agent consisting essentially of:

(a) from about 45% by weight to about 55% by weight of a combination of 1233zd(E) and 1336mzz(Z); and

(b) from about 40% to about 50% by weight of isobutane, methyl formate and combinations of these, and optionally CO2, provided that said methyl formate when present is present in an amount of less than about 15%. For the purposes of convenience, blowing agents in accordance with this paragraph are referred to herein as Blowing Agent 11.

The present invention includes blowing agents for producing thermoplastic foams with excellent thermal insulating properties (including preferably low aged lambda) and low foam density, said blowing agent consisting essentially of:

(a) from about 35% by weight to about 45% by weight of 1233zd(E);

(b) from about 10% by weight to about 15% by weight 1336mzz(Z);

(c) from about 30% to about 45% by weight of isobutane; and

(d) optionally methyl formate and optionally CO2, provided that said methyl formate when present is present in an amount of less than about 15%.

For the purposes of convenience, blowing agents in accordance with this paragraph are referred to herein as Blowing Agent 1J.

The present invention includes blowing agents for producing thermoplastic foams with excellent thermal insulating properties (including preferably low aged lambda) and low foam density, said blowing agent consisting essentially of:

(a) from about 45% by weight to about 55% by weight of 1224yd(Z);

(b) from about 40% by weight to about 50% by weight of isobutane; and

(d) optionally methyl formate and optionally CO2, provided that said methyl formate when present is present in an amount of not greater than about 10%. For the purposes of convenience, blowing agents in accordance with this paragraph are referred to herein as Blowing Agent 1K1.

The present invention includes blowing agents for producing thermoplastic foams with excellent thermal insulating properties (including preferably low aged lambda) and low foam density, said blowing agent consisting essentially of:

(a) from about 45% by weight to about 55% by weight of 1224yd(Z);

(b) from about 35% by weight to about 50% by weight of isobutane, DME or combinations of these; and

(d) optionally methyl formate and optionally CO2, provided that said methyl formate when present is present in an amount of not greater than about 10%. For the purposes of convenience, blowing agents in accordance with this paragraph are referred to herein as Blowing Agent 1K2.

The present invention includes blowing agents for producing thermoplastic foams with excellent thermal insulating properties (including preferably low aged lambda) and low foam density, said blowing agent consisting essentially of:

(a) from about 45% by weight to about 55% by weight of 1224yd(Z);

(b) from about 35% by weight to about 40% by weight of DME;

(d) about 10% by weight of methyl formate; and

(e) optionally CO2.

For the purposes of convenience, blowing agents in accordance with this paragraph are referred to herein as Blowing Agent 1L.

The present invention includes blowing agents for producing thermoplastic foams with excellent thermal insulating properties (including preferably low aged lambda) and low foam density, said blowing agent consisting essentially of:
(a) from about 50% by weight to about 60% by weight of a combination of 1233zd(E) and 1336mzz(Z);
(b) from about 25% to about 30% by weight of isobutane;
(c) from about 10% to about 15% by weight of methyl formate; and
(d) about 3% by weight of CO₂.

For the purposes of convenience, blowing agents in accordance with this paragraph are referred to herein as Blowing Agent 1M.

The present invention includes blowing agents for producing thermoplastic foams with excellent thermal insulating properties (including preferably low aged lambda) and low foam density, said blowing agent consisting essentially of:
(a) from about 40% by weight to about 45% by weight of 1233zd(E);
(b) from about 10% by weight to about 15% by weight of 1336mzz(E);
(b) from about 25% to about 30% by weight of isobutane;
(c) from about 10% to about 15% by weight of methyl formate; and
(d) about 3% by weight of CO2.

For the purposes of convenience, blowing agents in accordance with this paragraph are referred to herein as Blowing Agent 1N.

The present invention includes blowing agents for producing thermoplastic foams with excellent thermal insulating properties (including preferably low aged lambda) and low foam density, said blowing agent consisting essentially of:
(a) about 50% by weight of 1224yd(Z);
(b) about 37% by weight of one or more of isobutane, DME and combinations of these;
(b) about 9% by weight of methyl formate; and
(d) about 3% by weight of CO2.

For the purposes of convenience, blowing agents in accordance with this paragraph are referred to herein as Blowing Agent 1O.

The present invention includes blowing agents for producing thermoplastic foams with excellent thermal insulating properties (including preferably low aged lambda) and low foam density, said blowing agent comprising:

(a) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 30% to about 60% by weight of isobutane, methyl formate and combinations of these, provided that said isobutane is present in the blowing agent in an amount of at least about 15% by weight, and further provided that the amount of (a) and (b) in the blowing agent is not less than about 90% by weight. For the purposes of convenience, blowing agents in accordance with this paragraph are referred to herein as Blowing Agent 1P.

The present invention includes blowing agents for producing thermoplastic foams with excellent thermal insulating properties (including preferably low aged lambda) and low foam density, said blowing agent comprising:

(a) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 30% to about 60% by weight of isobutane, methyl formate and combinations of these, provided that said isobutane is present in the blowing agent in an amount of at least about 15% by weight, and further provided that the amount of (a) and (b) in the blowing agent is not less than about 95% by weight.

For the purposes of convenience, blowing agents in accordance with this paragraph are referred to herein as Blowing Agent 1Q.

The present invention includes blowing agents for producing thermoplastic foams with excellent thermal insulating properties (including preferably low aged lambda) and low foam density, said blowing agent comprising:

(a) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these; and

(b) from about 30% to about 60% by weight of isobutane, methyl formate and combinations of these, provided that said isobutane is present in the blowing agent in an amount of at least about 15% by weight, and further provided that the amount of (a) and (b) in the blowing agent is not less than about 97% by weight. For the purposes of convenience, blowing agents in accordance with this paragraph are referred to herein as Blowing Agent 1R.

The present invention includes blowing agents for producing thermoplastic foams with excellent thermal insulating properties (including preferably low aged lambda) and low foam density, said blowing agent consisting essentially of:

(a) from about 40% by weight to about 70% by weight of one or more HFOs three or four carbon atoms and/or an HFCOs having three or four carbon atoms being selected from the group consisting of 1224yd(Z), 1233zd(E), 1336mzz(Z) and combinations of these provided that said 1336mzz(Z) is present in the blowing agent in an amount of from about 8% to about 22% by weight; and

(b) from about 30% to about 60% by weight of isobutane, methyl formate and combinations of these, provided that said isobutane is present in the blowing agent in an amount of at least about 15% by weight. For the purposes of convenience, blowing agents in accordance with this paragraph are referred to herein as Blowing Agent 1S.

The present invention includes blowing agents for producing thermoplastic foams with excellent thermal insulating properties (including preferably low aged lambda) and low foam density, said blowing agent consisting essentially of:

(a) about 43% by weight of 1233zd(E);

(b) about 14% by weight of 1336mmz(Z); and

(c) about 43% by weight of isobutane.

For the purposes of convenience, blowing agents in accordance with this paragraph are referred to herein as Blowing Agent 1T.

The present invention includes blowing agents for producing thermoplastic foams with excellent thermal insulating properties (including preferably low aged lambda) and low foam density, said blowing agent consisting essentially of:

(a) about 37.5 by weight of 1233zd(E);

(b) about 12.5% by weight of 1336mmz(Z);

(c) about 37.5% by weight of isobutane; and

(d) about 12.5% by weight of methyl formate.

For the purposes of convenience, blowing agents in accordance with this paragraph are referred to herein as Blowing Agent 1U1.

The present invention includes blowing agents for producing thermoplastic foams with excellent thermal insulating properties (including preferably low aged lambda) and low foam density, said blowing agent consisting essentially of:

(a) about 40% by weight of 1233zd(E);

(b) about 13% by weight of 1336mmz(Z);

(c) about 33% by weight of isobutane; and

(d) about 13% by weight of methyl formate.

For the purposes of convenience, blowing agents in accordance with this paragraph are referred to herein as Blowing Agent 1U2.

The present invention includes blowing agents for producing thermoplastic foams with excellent thermal insulating properties (including preferably low aged lambda) and low foam density, said blowing agent consisting essentially of:

(a) about 41% by weight of 1233zd(E);

(b) about 14% by weight of 1336mmz(Z);

(c) about 28% by weight of isobutane;

(d) about 14% by weight of methyl formate; and

(e) about 3% by weight of CO₂.

For the purposes of convenience, blowing agents in accordance with this paragraph are referred to herein as Blowing Agent 1U3.

The present invention includes blowing agents for producing thermoplastic foams with excellent thermal insulating properties (including preferably low aged lambda) and low foam density, said blowing agent consisting essentially of:

(a) about 28% by weight of 1336mmz(Z);

(b) about 39.5% by weight of ethanol;

(c) about 32.5% by weight of CO₂.

For the purposes of convenience, blowing agents in accordance with this paragraph are referred to herein as Blowing Agent 1V.

The present invention includes blowing agents for producing thermoplastic foams with excellent thermal insulating properties (including preferably low aged lambda) and low foam density, said blowing agent consisting essentially of:

(a) about 53% by weight of 1224yd(Z); and

(b) about 47% by weight of isobutane.

For the purposes of convenience, blowing agents in accordance with this paragraph are referred to herein as Blowing Agent 1W1.

The present invention includes blowing agents for producing thermoplastic foams with excellent thermal insulating properties (including preferably low aged lambda) and low foam density, said blowing agent consisting essentially of:

(a) about 48% by weight of 1224yd(Z);

(b) about 42% by weight of isobutane; and

(c) about 9% by weight of methyl formate.

For the purposes of convenience, blowing agents in accordance with this paragraph are referred to herein as Blowing Agent 1W2.

The present invention includes blowing agents for producing thermoplastic foams with excellent thermal insulating properties (including preferably low aged lambda) and low foam density, said blowing agent consisting essentially of:

(a) about 50% by weight of 1224yd(Z);

(b) about 37.5% by weight of isobutane;

(c) about 9% by weight of methyl formate; and

(d) about 3% by weight of CO₂.

For the purposes of convenience, blowing agents in accordance with this paragraph are referred to herein as Blowing Agent 1W3.

The present invention includes blowing agents for producing thermoplastic foams with excellent thermal insulating properties (including preferably low aged lambda) and low foam density, said blowing agent consisting essentially of:

(d) about 51.6% by weight of 1224yd(Z);

(e) about 38.7% by weight of DME; and

(f) about 9% by weight of methyl formate.

For the purposes of convenience, blowing agents in accordance with this paragraph are referred to herein as Blowing Agent 1X1.

The present invention includes blowing agents for producing thermoplastic foams with excellent thermal insulating properties (including preferably low aged lambda) and low foam density, said blowing agent consisting essentially of:

(a) about 50% by weight of 1224yd(Z);

(b) about 37.5% by weight of DME;

(c) about 9% by weight of methyl formate; and

(d) about 3% by weight of CO₂.

For the purposes of convenience, blowing agents in accordance with this paragraph are referred to herein as Blowing Agent 1X2.

The present invention includes blowing agents for producing thermoplastic foams with excellent thermal insulating properties (including preferably low aged lambda) and low foam density, said blowing agent comprising:

(a) from about 45% by weight to about 70% by weight of a combination of 1233zd(E) and 1336mzz(Z), provided that said 1336mzz(Z) is present in the blowing agent composition in an amount of from about 8% to about 22% by weight; and

(b) from about 30% to about 60% by weight of isobutane, methyl formate and combinations of these, provided that said isobutane is present in the blowing agent composition in an amount of at least about 15% by weight, and further provided that the amount of (a) and (b) in the blowing agent composition is not less than about 90% by weight. For the purposes of convenience, blowing agents in accordance with this paragraph are referred to herein as Blowing Agent 2A.

The present invention includes blowing agents for producing thermoplastic foams with excellent thermal insulating properties (including preferably low aged lambda) and low foam density, said blowing agent comprising:

(a) from about 45% by weight to about 70% by weight of a combination of 1233zd(E) and 1336mzz(Z), provided that said 1336mzz(Z) is present in the blowing agent composition in an amount of from about 8% to about 22% by weight; and

(b) from about 30% to about 60% by weight of isobutane, methyl formate and combinations of these, provided that said isobutane is present in the blowing agent composition in an amount of at least about 15% by weight, and further provided that the amount of (a) and (b) in the blowing agent composition is not less than about 95% by weight. For the purposes of convenience, blowing agents in accordance with this paragraph are referred to herein as Blowing Agent 2B.

The present invention includes blowing agents for producing thermoplastic foams with excellent thermal insulating properties (including preferably low aged lambda) and low foam density, said blowing agent comprising:

(a) from about 45% by weight to about 70% by weight of a combination of 1233zd(E) and 1336mzz(Z), provided that said 1336mzz(Z) is present in the blowing agent composition in an amount of from about 8% to about 22% by weight; and

(b) from about 30% to about 60% by weight of isobutane, methyl formate and combinations of these, provided that said isobutane is present in the blowing agent composition in an amount of at least about 15% by weight, and further provided that the amount of (a) and (b) in the blowing agent composition is not less than about 97% by weight. For the purposes of convenience, blowing agents in accordance with this paragraph are referred to herein as Blowing Agent 2C.

The present invention includes blowing agents for producing thermoplastic foams with excellent thermal insulating properties (including preferably low aged lambda) and low foam density, said blowing agent consisting essentially of:

(a) from about 45% by weight to about 70% by weight of a combination of 1233zd(E) and 1336mzz(Z), provided that said 1336mzz(Z) is present in the blowing agent composition in an amount of from about 8% to about 22% by weight; and

(b) from about 30% to about 60% by weight of isobutane, methyl formate and combinations of these, provided that said isobutane is present in the blowing agent composition in an amount of at least about 15% by weight, and further provided that the amount of (a) and (b) in the blowing agent composition is not less than about 97% by weight. For the purposes of convenience, blowing agents in accordance with this paragraph are referred to herein as Blowing Agent 2D.

The present invention includes blowing agents for producing thermoplastic foams with excellent thermal insulating properties (including preferably low aged lambda) and low foam density, said blowing agents comprising:

(a) from about 10% by weight to about 20% by weight of 1336mzz(Z);

(b) from about 35% by weight to about 55% by weight of 1233zd(E); and

(c) from about 30% to about 60% by weight of isobutane, methyl formate and combinations of these, provided that said isobutane is present in the blowing agent in an amount of at least about 15% by weight, and further provided that the amount of (a), (b) and (c) in the blowing agent composition is not less than about 95% by weight. For the purposes of convenience, blowing agents in accordance with this paragraph are referred to herein as Blowing Agent 2E.

The present invention includes blowing agents for producing thermoplastic foams with excellent thermal insulating properties (including preferably low aged lambda) and low foam density, said blowing agents comprising:

(a) from about 10% by weight to about 20% by weight of 1336mzz(Z);

(b) from about 35% by weight to about 55% by weight of 1233zd(E); and

(c) from about 30% to about 60% by weight of isobutane, methyl formate and combinations of these, provided that said isobutane is present in the blowing agent in an amount of at least about 15% by weight, and further provided that the amount of (a), (b) and (c) in the blowing agent composition is not less than about 95% by weight. For the purposes of convenience, blowing agents in accordance with this paragraph are referred to herein as Blowing Agent 2F.

The present invention includes blowing agents for producing thermoplastic foams with excellent thermal insulating properties (including preferably low aged lambda) and low foam density, said blowing agents consisting essentially of:

(a) from about 10% by weight to about 20% by weight of 1336mzz(Z);

(b) from about 35% by weight to about 55% by weight of 1233zd(E); and

(c) from about 30% to about 60% by weight of isobutane, methyl formate and combinations of these, provided that said isobutane is present in the blowing agent in an amount of at least about 15% by weight. For the purposes of convenience, blowing agents in accordance with this paragraph are referred to herein as Blowing Agent 2G.

The present invention includes blowing agents for producing thermoplastic foams with excellent thermal insulating properties (including preferably low aged lambda) and low foam density, said blowing agent comprising:

(a) from about 10% to about 20% by weight of 1336mzz(Z);

(b) from about 35% to about 50% by weight of 1233zd(E); and

(c) from about 15% to about 45% by weight of isobutane, provided that the amount of (a), (b) and (c) in the blowing agent composition is not less than about 80% by weight. For the purposes of convenience, blowing agents in accordance with this paragraph are referred to herein as Blowing Agent 2H.

The present invention includes blowing agents for producing thermoplastic foams with excellent thermal insulating properties (including preferably low aged lambda) and low foam density, said blowing agent comprising:

(a) from about 10% to about 20% by weight of 1336mzz(Z);

(b) from about 35% to about 50% by weight of 1233zd(E); and

(c) from about 40% to about 45% by weight of isobutane, provided that the amount of (a), (b) and (c) in the blowing agent composition is not less than about 95% by weight. For the purposes of convenience, blowing agents in accordance with this paragraph are referred to herein as Blowing Agent 21.

The present invention includes blowing agents for producing thermoplastic foams with excellent thermal insulating properties (including preferably low aged lambda) and low foam density, said blowing agent comprising:

(a) from about 10% to about 20% by weight of 1336mzz(Z);

(b) from about 35% to about 50% by weight of 1233zd(E); and

(c) from about 40% to about 45% by weight of isobutane, provided that the amount of (a), (b) and (c) in the blowing agent composition is not less than about 97% by weight. For the purposes of convenience, blowing agents in accordance with this paragraph are referred to herein as Blowing Agent 2J.

The present invention includes blowing agents for producing thermoplastic foams with excellent thermal insulating properties (including preferably low aged lambda) and low foam density, said blowing agent consisting essentially of:

(a) from about 10% to about 20% by weight of 1336mzz(Z);

(b) from about 35% to about 50% by weight of 1233zd(E); and

(c) from about 40% to about 45% by weight of isobutane. For the purposes of convenience, blowing agents in accordance with this paragraph are referred to herein as Blowing Agent 2K.

The present invention includes blowing agents for producing thermoplastic foams with excellent thermal insulating properties (including preferably low aged lambda) and low foam density, said blowing agent comprising:

(a) from about 10% to about 20% by weight of 1336mzz(Z);

(b) from about 35% to about 50% by weight of 1233zd(E);

(c) from about 15% to about 40% by weight of isobutane; and

(d) from about 10% to about 20% by weight to about of methyl formate, provided that the amount of (a), (b), (c) and (d) in the blowing agent composition is not less than about 95% by weight. For the purposes of convenience, blowing agents in accordance with this paragraph are referred to herein as Blowing Agent 2L.

The present invention includes blowing agents for producing thermoplastic foams with excellent thermal insulating properties (including preferably low aged lambda) and low foam density, said blowing agent comprising:

(a) from about 10% to about 20% by weight of 1336mzz(Z);

(b) from about 35% to about 50% by weight of 1233zd(E);

(c) from about 15% to about 40% by weight of isobutane; and

(d) from about 10% to about 20% by weight to about of methyl formate, provided that the amount of (a), (b), (c) and (d) in the blowing agent composition is not less than about 97% by weight. For the purposes of convenience, blowing agents in accordance with this paragraph are referred to herein as Blowing Agent 2M.

The present invention includes blowing agents for producing thermoplastic foams with excellent thermal insulating properties (including preferably low aged lambda) and low foam density, said blowing agent consisting essentially of:

(a) from about 10% to about 20% by weight of 1336mzz(Z);

(b) from about 35% to about 50% by weight of 1233zd(E);

(c) from about 15% to about 40% by weight of isobutane; and

(d) from about 10% to about 20% by weight to about of methyl formate.

For the purposes of convenience, blowing agents in accordance with this paragraph are referred to herein as Blowing Agent 2N.

The present invention includes blowing agents for producing thermoplastic foams with excellent thermal insulating properties (including preferably low aged lambda) and low foam density, said blowing agents comprising:

(a) from about 45% by weight to about 55% by weight of 1224yd(Z); and

(b) from about 40% by weight to about 50% by weight of isobutane. For the purposes of convenience, blowing agents in accordance with this paragraph are referred to herein as Blowing Agent 3A.

The present invention includes blowing agents for producing thermoplastic foams with excellent thermal insulating properties (including preferably low aged lambda) and low foam density, said blowing agents comprising:

(a) from about 45% by weight to about 55% by weight of 1224yd(Z);

(b) from about 40% by weight to about 50% by weight of isobutane, provided that the amount of (a) and (b) in the blowing agent composition is not less than about 90% by weight. For the purposes of convenience, blowing agents in accordance with this paragraph are referred to herein as Blowing Agent 3B.

The present invention includes blowing agents for producing thermoplastic foams with excellent thermal insulating properties (including preferably low aged lambda) and low foam density, said blowing agents comprising:

(a) from about 45% by weight to about 55% by weight of 1224yd(Z);

(b) from about 40% by weight to about 50% by weight of isobutane; and

(c) methyl formate, provided that the amount of (a), (b) and (c) in the blowing agent composition is not less than about 95% by weight. For the purposes of convenience, blowing agents in accordance with this paragraph are referred to herein as Blowing Agent 3C.

The present invention includes blowing agents for producing thermoplastic foams with excellent thermal insulating properties (including preferably low aged lambda) and low foam density, said blowing agents comprising:

(a) from about 45% by weight to about 55% by weight of 1224yd(Z);

(b) from about 40% by weight to about 50% by weight of isobutane; and

(c) at least about 5% by weight of methyl formate, provided that the amount of (a), (b) and (c) in the blowing agent composition is not less than about 95% by weight. For the purposes of convenience, blowing agents in accordance with this paragraph are referred to herein as Blowing Agent 3D.

The present invention includes blowing agents for producing thermoplastic foams with excellent thermal insulating properties (including preferably low aged lambda) and low foam density, said blowing agent consisting essentially of:

(a) from about 45% by weight to about 55% by weight of 1224yd(Z);

(b) from about 40% by weight to about 50% by weight of isobutane; and

(c) at least about 5% by weight of methyl formate. For the purposes of convenience, blowing agent in accordance with this paragraph are referred to herein as Blowing Agent 3E.

The present invention includes blowing agents for producing thermoplastic foams with excellent thermal insulating properties (including preferably low aged lambda) and low foam density, said blowing agent consisting essentially of:

(a) about 53% by weight of 1224yd(Z); and

(b) about 47% by weight of isobutane.

For the purposes of convenience, blowing agent in accordance with this paragraph are referred to herein as Blowing Agent 3F.

The present invention includes blowing agents for producing thermoplastic foams with excellent thermal insulating properties (including preferably low aged lambda) and low foam density, said blowing agent consisting essentially of:

(a) about 49% by weight of 1224yd(Z);

(b) about 42% by weight of isobutane; and

(c) about 9% by weight of methyl formate. For the purposes of convenience, blowing agents in accordance with this paragraph are referred to herein as Blowing Agent 3G.

The present invention includes blowing agents for producing thermoplastic foams with excellent thermal insulating properties (including preferably low aged lambda) and low foam density, said blowing agent consisting essentially of:

(a) about 12.5% by weight of 1336mzz(Z);

(b) about 37.5% by weight of 1233zd(E);

(b) about 37.5% by weight of isobutane; and

(c) about 12.5% by weight of methyl formate. For the purposes of convenience, blowing agents in accordance with this paragraph are referred to herein as Blowing Agent 4A.

The present invention includes blowing agents for producing thermoplastic foams with excellent thermal insulating properties (including preferably low aged lambda) and low foam density, said blowing agents consisting essentially of:

(a) about 13% by weight of 1336mzz(Z);

(b) about 40% by weight of 1233zd(E);

(c) about 33% by weight of isobutane; and

(d) about 13% by weight of methyl formate.

For the purposes of convenience, blowing agents in accordance with this paragraph are referred to herein as Blowing Agent 4B.

The present invention includes blowing agents for producing thermoplastic foams with excellent thermal insulating properties (including preferably low aged lambda) and low foam density, said blowing agents consisting essentially of:

(a) about 14% by weight of 1336mzz(Z);

(b) about 43% by weight of 1233zd(E); and

(c) about 43% by weight of isobutane.

For the purposes of convenience, blowing agents in accordance with this paragraph are referred to herein as Blowing Agent 4C.

The present invention includes blowing agents for producing thermoplastic foams with excellent thermal insulating properties (including preferably low aged lambda) and low foam density, said blowing agents consisting essentially of:

(a) about 16% by weight of 1336mzz(Z);

(b) about 48% by weight of 1233zd(E);

(c) about 16% by weight of isobutane;

(d) about 16% by weight of methyl formate; and

(e) about 4% by weight of carbon dioxide.

For the purposes of convenience, blowing agents in accordance with this paragraph are referred to herein as Blowing Agent 4D.

The present invention also includes methods of forming foam that use the blowing agents of the present invention, including Blowing Agents 1-4, and the present invention also includes foams that contain and/or are made by methods that use the blowing agents of the present invention, including Blowing Agents 1-4, as explained in detail herein. As used herein, reference to a defined blowing agent or a range of defined blowing agents, such as Blowing Agents 1-4, includes all blowing agents so defined, including any numbered blowing agent that includes a suffix, such as Blowing Agent 4 meanings that each of Blowing Agent $A, Blowing Agents 4B, Blowing Agent 4C and Blowing Agent 4D are specifically included.

### BRIEF DESCRIPTION OF THE DRAWING

FIG. 1 is a schematic representation of an extrusion system and process according to one embodiment of the invention and according to the examples herein.

FIG. 2 is a chart showing test results from Comparative Examples C1 and C22.

FIG. 3 is a chart showing test results from Comparative Examples C24 and C42.

### DEFINITIONS

1234ze means 1,1,1,3-tetrafluoropropene, without limitation as to isomeric form.

Trans1234ze and 1234ze(E) each mean trans1,3,3,3-tetrafluoropropene. 1233zd means 1-chloro-3,3,3-trifluoropropene, without limitation as to isomeric form.

trans1233zd and 1233zd(E) each means trans1-chloro-3,3,3-trifluoropropene.

cis1224yd means cis1-chloro-2,3,3,3-tetrafluoropropane.

Cis1336mzz and 1336mzz(Z) each mean cis-1,1,1,4,4,4-hexafluorobutene.

Trans1336mzz and 1336mzz(E) each mean trans1,1,1,4,4,4-hexafluorobutene.

Methyl formate means the following compou

[symbol]

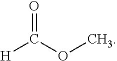

Methylal means dimethoxymethane ((CH3O)2CH2).

Dimethyl ether and DME each means the following comp

[symbol]

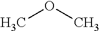

Isobutane and iC4 and isoC4 each mean 2-methyl propane.

Ethanol and EtOH each mean CH₃CH₂OH.

Closed cell foam means that a substantial volume percentage of the cells in the foam are closed, for example, about 20% by volume or more.

Styrene moiety means the compounds having the structure

[symbol]

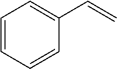

and all compounds in which one or more of the hydrogens are substituted.

[symbol]

Polystyrene, polystyrene resin, and PS each mean a polymer that is made from monomers that includes the styrene moiety, including homopolymers thereof, copolymers, and blends of polymers that include such homopolymers and/or copolymers.

XPS foam means polystyrene that has been formed into a foam in an extrusion process.

Aged thermal conductivity and aged lambda each means thermal conductivity measured as described in the examples.

Density means foam density as measured in the examples.

### DETAILED DESCRIPTION

Blowing Agent

The blowing agent of the present invention, including each of Blowing Agents 1-4, may include one or more co-blowing agents other than those specified, provided they are of a type and amount that does not impair the ability of the blowing agent to be used to form polystyrene foam, and in particular XPS foam, having one or more of the density and thermal conductivity properties described herein as aspects of the invention. Within this parameter, and by way of example only, the blowing agents of present blowing agent of the present invention, including each of Blowing Agents 1-4, may further include, in certain applications and in appropriate amounts, one or more of the following: saturated hydrocarbons having 3 to 5 carbon atoms such as propane, normal butane, and cyclopentane, ethers such as ethyl ether, diethylether, and methyl ethyl ether, alkyl chlorides such as methyl chloride and ethyl chloride, alcohols such as methanol, propyl alcohol, isopropyl alcohol, butyl alcohol, sec-butyl alcohol, tert-butyl alcohol, aryl alcohol, crotyl alcohol, and propargyl alcohol, ketones and esters.

Other additives may also be included, again to the extent that the type and amount does not impair the ability of the blowing agent to be used to form polystyrene foam, and in particular XPS foam, having the density and thermal conductivity properties described herein as aspects of the invention. Within this parameter, and by way of example only, the blowing agents of present blowing agent of the present invention, including each of Blowing Agents 1-4, may include one or more of the following: processing aids, flame retardants, coloring agents, stabilizers, surfactants, polymer modifiers, toughening agents, colorants, dyes, solubility enhancers, rheology modifiers, plasticizing agents, flammability suppressants, antimicrobial agents, viscosity reduction modifiers, fillers, vapor pressure modifiers, nucleating agents, catalysts and the like.

Foams

The present invention includes also thermoplastic foam, including and preferably PS foam and even more preferably XPS foam, comprising PS resin and a blowing agent of the present invention, including each of Blowing Agents 1-4.

The present invention includes XPS foam comprising:

(a) thermoplastic polymer cells comprising PS cell walls forming closed cells; and

(b) Blowing Agent 1 contained in the closed cells. For the purposes of convenience, foams in accordance with this paragraph are referred to herein as Foam 1.

The present invention includes XPS foam comprising:

(a) thermoplastic polymer cells comprising PS cell walls forming closed cells; and

(b) Blowing Agent 2 contained in the closed cells. For the purposes of convenience, foams in accordance with this paragraph are referred to herein as Foam 2.

The present invention includes XPS foam comprising:

(a) thermoplastic polymer cells comprising PS cell walls forming closed cells; and

(b) Blowing Agent 3 contained in the closed cells. For the purposes of convenience, foams in accordance with this paragraph are referred to herein as Foam 3.

The present invention includes XPS foam comprising:

(a) thermoplastic polymer cells comprising PS cell walls forming closed cells; and

(b) Blowing Agent 4 contained in the closed cells. For the purposes of convenience, foams in accordance with this paragraph are referred to herein as Foam 4.

The present invention includes XPS foam made with Blowing Agent (using the Blowing Agent numbers as defined above) as identified in the following XPS Foam Table and having the foam properties as defined in the XPS Foam Table:

### XPS Foam Table

| | | Foam Density, | Aged Thermal |
|---|---|---|---|
| Foam No. | Blowing Agent | kg/m³ | Conductivity, mW/Mk |
| XPSF1A1 | 1A | =<34 | =<34 |
| XPSF1B1 | 1A | =<34 | =<33 |
| XPSF1C1 | 1A | =<34 | =<32 |
| XPSF1D1 | 1A | =<34 | =<31 |
| XPSF1E1 | 1A | =<34 | =<30 |
| XPSF1F1 | 1A | =<34 | =<29 |
| XPSF1A2 | 1A | =<33 | =<34 |
| XPSF1B2 | 1A | =<33 | =<33 |
| XPSF1C2 | 1A | =<33 | =<32 |
| XPSF1D2 | 1A | =<33 | =<31 |
| XPSF1E2 | 1A | =<33 | =<30 |
| XPSF1F2 | 1A | =<33 | =<29 |
| XPSF1A3 | 1A | =<32 | =<34 |
| XPSF1B3 | 1A | =<32 | =<33 |
| XPSF1C3 | 1A | =<32 | =<32 |
| XPSF1D3 | 1A | =<32 | =<31 |
| XPSF1E3 | 1A | =<32 | =<30 |
| XPSF1F3 | 1A | =<32 | =<29 |
| XPSF1A4 | 1A | =<31 | =<34 |
| XPSF1B4 | 1A | =<31 | =<33 |
| XPSF1C4 | 1A | =<31 | =<32 |
| XPSF1D4 | 1A | =<31 | =<31 |
| XPSF1E4 | 1A | =<31 | =<30 |
| XPSF1F4 | 1A | =<30 | =<29 |
| XPSF1A5 | 1A | =<30 | =<34 |
| XPSF1B5 | 1A | =<30 | =<33 |
| XPSF1C5 | 1A | =<30 | =<32 |
| XPSF1D5 | 1A | =<30 | =<31 |
| XPSF1E5 | 1A | =<30 | =<30 |
| XPSF1F5 | 1A | =<30 | =<29 |
| XPSF2A1 | 1D | =<34 | =<34 |
| XPSF2B1 | 1D | =<34 | =<33 |
| XPSF2C1 | 1D | =<34 | =<32 |
| XPSF2D1 | 1D | =<34 | =<31 |
| XPSF2E1 | 1D | =<34 | =<30 |
| XPSF2F1 | 1D | =<34 | =<29 |
| XPSF2A2 | 1D | =<33 | =<34 |
| XPSF2B2 | 1D | =<33 | =<33 |
| XPSF2C2 | 1D | =<33 | =<32 |
| XPSF2D2 | 1D | =<33 | =<31 |
| XPSF2E2 | 1D | =<33 | =<30 |
| XPSF2F2 | 1D | =<33 | =<29 |
| XPSF2A3 | 1D | =<32 | =<34 |
| XPSF2B3 | 1D | =<32 | =<33 |
| XPSF2C3 | 1D | =<32 | =<32 |
| XPSF2D3 | 1D | =<32 | =<31 |
| XPSF2E3 | 1D | =<32 | =<30 |
| XPSF2F3 | 1D | =<32 | =<29 |
| XPSF2A4 | 1D | =<31 | =<34 |
| XPSF2B4 | 1D | =<31 | =<33 |
| XPSF2C4 | 1D | =<31 | =<32 |
| XPSF2D4 | 1D | =<31 | =<31 |
| XPSF2E4 | 1D | =<31 | =<30 |
| XPSF2F4 | 1D | =<30 | =<29 |
| XPSF2A5 | 1D | =<30 | =<34 |
| XPSF2B5 | 1D | =<30 | =<33 |
| XPSF2C5 | 1D | =<30 | =<32 |
| XPSF2D5 | 1D | =<30 | =<31 |
| XPSF2E5 | 1D | =<30 | =<30 |
| XPSF2F5 | 1D | =<30 | =<29 |
| XPSF3A1 | 1F | =<34 | =<34 |
| XPSF3B1 | 1F | =<34 | =<33 |
| XPSF3C1 | 1F | =<34 | =<32 |
| XPSF3D1 | 1F | =<34 | =<31 |
| XPSF3E1 | 1F | =<34 | =<30 |
| XPSF3F1 | 1F | =<34 | =<29 |
| XPSF3A2 | 1F | =<33 | =<34 |
| XPSF3B2 | 1F | =<33 | =<33 |
| XPSF3C2 | 1F | =<33 | =<32 |
| XPSF3D2 | 1F | =<33 | =<31 |
| XPSF3E2 | 1F | =<33 | =<30 |
| XPSF3F2 | 1F | =<33 | =<29 |
| XPSF3A3 | 1F | =<32 | =<34 |
| XPSF3B3 | 1F | =<32 | =<33 |
| XPSF3C3 | 1F | =<32 | =<32 |
| XPSF3D3 | 1F | =<32 | =<31 |
| XPSF3E3 | 1F | =<32 | =<30 |
| XPSF3F3 | 1F | =<32 | =<29 |
| XPSF3A4 | 1F | =<31 | =<34 |
| XPSF3B4 | 1F | =<31 | =<33 |
| XPSF3C4 | 1F | =<31 | =<32 |
| XPSF3D4 | 1F | =<31 | =<31 |
| XPSF3E4 | 1F | =<31 | =<30 |
| XPSF3F4 | 1F | =<30 | =<29 |
| XPSF3A5 | 1F | =<30 | =<34 |
| XPSF3B5 | 1F | =<30 | =<33 |
| XPSF3C5 | 1F | =<30 | =<32 |
| XPSF3D5 | 1F | =<30 | =<31 |
| XPSF3E5 | 1F | =<30 | =<30 |
| XPSF3F5 | 1F | =<30 | =<29 |
| XPSF4A1 | 1G | =<34 | =<34 |
| XPSF4B1 | 1G | =<34 | =<33 |
| XPSF4C1 | 1G | =<34 | =<32 |
| XPSF4D1 | 1G | =<34 | =<31 |
| XPSF4E1 | 1G | =<34 | =<30 |
| XPSF4F1 | 1G | =<34 | =<29 |
| XPSF4A2 | 1G | =<33 | =<34 |
| XPSF4B2 | 1G | =<33 | =<33 |
| XPSF4C2 | 1G | =<33 | =<32 |
| XPSF4D2 | 1G | =<33 | =<31 |
| XPSF4E2 | 1G | =<33 | =<30 |
| XPSF4F2 | 1G | =<33 | =<29 |
| XPSF4A3 | 1G | =<32 | =<34 |
| XPSF4B3 | 1G | =<32 | =<33 |
| XPSF4C3 | 1G | =<32 | =<32 |
| XPSF4D3 | 1G | =<32 | =<31 |
| XPSF4E3 | 1G | =<32 | =<30 |
| XPSF4F3 | 1G | =<32 | =<29 |
| XPSF4A4 | 1G | =<31 | =<34 |
| XPSF4B4 | 1G | =<31 | =<33 |
| XPSF4C4 | 1G | =<31 | =<32 |
| XPSF4D4 | 1G | =<31 | =<31 |
| XPSF4E4 | 1G | =<31 | =<30 |
| XPSF4F4 | 1G | =<30 | =<29 |
| XPSF4A5 | 1G | =<30 | =<34 |
| XPSF4B5 | 1G | =<30 | =<33 |
| XPSF4C5 | 1G | =<30 | =<32 |
| XPSF4D5 | 1G | =<30 | =<31 |
| XPSF4E5 | 1G | =<30 | =<30 |
| XPSF4F5 | 1G | =<30 | =<29 |
| XPSF5A1 | 1J | =<34 | =<34 |
| XPSF5B1 | 1J | =<34 | =<33 |
| XPSF5C1 | 1J | =<34 | =<32 |
| XPSF5D1 | 1J | =<34 | =<31 |
| XPSF5E1 | 1J | =<34 | =<30 |
| XPSF5F1 | 1J | =<34 | =<29 |
| XPSF5A2 | 1J | =<33 | =<34 |
| XPSF5B2 | 1J | =<33 | =<33 |
| XPSF5C2 | 1J | =<33 | =<32 |
| XPSF5D2 | 1J | =<33 | =<31 |
| XPSF5E2 | 1J | =<33 | =<30 |
| XPSF5F2 | 1J | =<33 | =<29 |
| XPSF5A3 | 1J | =<32 | =<34 |
| XPSF5B3 | 1J | =<32 | =<33 |
| XPSF5C3 | 1J | =<32 | =<32 |
| XPSF5D3 | 1J | =<32 | =<31 |
| XPSF5E3 | 1J | =<32 | =<30 |
| XPSF5F3 | 1J | =<32 | =<29 |
| XPSF5A4 | 1J | =<31 | =<34 |
| XPSF5B4 | 1J | =<31 | =<33 |
| XPSF5C4 | 1J | =<31 | =<32 |
| XPSF5D4 | 1J | =<31 | =<31 |
| XPSF5E4 | 1J | =<31 | =<30 |
| XPSF5F4 | 1J | =<30 | =<29 |
| XPSF5A5 | 1J | =<30 | =<34 |
| XPSF5B5 | 1J | =<30 | =<33 |
| XPSF5C5 | 1J | =<30 | =<32 |
| XPSF5D5 | 1J | =<30 | =<31 |
| XPSF5E5 | 1J | =<30 | =<30 |
| XPSF5F5 | 1J | =<30 | =<29 |
| XPSF6A1 | 1K | =<34 | =<34 |
| XPSF6B1 | 1K | =<34 | =<33 |
| XPSF6C1 | 1K | =<34 | =<32 |
| XPSF6D1 | 1K | =<34 | =<31 |
| XPSF6E1 | 1K | =<34 | =<30 |
| XPSF6F1 | 1K | =<34 | =<29 |
| XPSF6A2 | 1K | =<33 | =<34 |
| XPSF6B2 | 1K | =<33 | =<33 |
| XPSF6C2 | 1K | =<33 | =<32 |
| XPSF6D2 | 1K | =<33 | =<31 |
| XPSF6E2 | 1K | =<33 | =<30 |
| XPSF6F2 | 1K | =<33 | =<29 |
| XPSF6A3 | 1K | =<32 | =<34 |
| XPSF6B3 | 1K | =<32 | =<33 |
| XPSF6C3 | 1K | =<32 | =<32 |
| XPSF6D3 | 1K | =<32 | =<31 |
| XPSF6E3 | 1K | =<32 | =<30 |
| XPSF6F3 | 1K | =<32 | =<29 |
| XPSF6A4 | 1K | =<31 | =<34 |
| XPSF6B4 | 1K | =<31 | =<33 |
| XPSF6C4 | 1K | =<31 | =<32 |
| XPSF6D4 | 1K | =<31 | =<31 |
| XPSF6E4 | 1K | =<31 | =<30 |
| XPSF6F4 | 1K | =<30 | =<29 |
| XPSF6A5 | 1K | =<30 | =<34 |
| XPSF6B5 | 1K | =<30 | =<33 |
| XPSF6C5 | 1K | =<30 | =<32 |
| XPSF6D5 | 1K | =<30 | =<31 |
| XPSF6E5 | 1K | =<30 | =<30 |
| XPSF6F5 | 1K | =<30 | =<29 |
| XPSF7A1 | 1L | =<34 | =<34 |
| XPSF7B1 | 1L | =<34 | =<33 |
| XPSF7C1 | 1L | =<34 | =<32 |
| XPSF7D1 | 1L | =<34 | =<31 |
| XPSF7E1 | 1L | =<34 | =<30 |
| XPSF7F1 | 1L | =<34 | =<29 |
| XPSF7A2 | 1L | =<33 | =<34 |
| XPSF7B2 | 1L | =<33 | =<33 |
| XPSF7C2 | 1L | =<33 | =<32 |
| XPSF7D2 | 1L | =<33 | =<31 |
| XPSF7E2 | 1L | =<33 | =<30 |
| XPSF7F2 | 1L | =<33 | =<29 |
| XPSF7A3 | 1L | =<32 | =<34 |
| XPSF7B3 | 1L | =<32 | =<33 |
| XPSF7C3 | 1L | =<32 | =<32 |
| XPSF7D3 | 1L | =<32 | =<31 |
| XPSF7E3 | 1L | =<32 | =<30 |
| XPSF7F3 | 1L | =<32 | =<29 |
| XPSF7A4 | 1L | =<31 | =<34 |
| XPSF7B4 | 1L | =<31 | =<33 |
| XPSF7C4 | 1L | =<31 | =<32 |
| XPSF7D4 | 1L | =<31 | =<31 |
| XPSF7E4 | 1L | =<31 | =<30 |
| XPSF7F4 | 1L | =<30 | =<29 |
| XPSF7A5 | 1L | =<30 | =<34 |
| XPSF7B5 | 1L | =<30 | =<33 |
| XPSF7C5 | 1L | =<30 | =<32 |
| XPSF7D5 | 1L | =<30 | =<31 |
| XPSF7E5 | 1L | =<30 | =<30 |
| XPSF7F5 | 1L | =<30 | =<29 |
| XPSF8A1 | 1N | =<34 | =<34 |
| XPSF8B1 | 1N | =<34 | =<33 |
| XPSF8C1 | 1N | =<34 | =<32 |
| XPSF8D1 | 1N | =<34 | =<31 |
| XPSF8E1 | 1N | =<34 | =<30 |
| XPSF8F1 | 1N | =<34 | =<29 |
| XPSF8A2 | 1N | =<33 | =<34 |
| XPSF8B2 | 1N | =<33 | =<33 |
| XPSF8C2 | 1N | =<33 | =<32 |
| XPSF8D2 | 1N | =<33 | =<31 |
| XPSF8E2 | 1N | =<33 | =<30 |
| XPSF8F2 | 1N | =<33 | =<29 |
| XPSF8A3 | 1N | =<32 | =<34 |
| XPSF8B3 | 1N | =<32 | =<33 |
| XPSF8C3 | 1N | =<32 | =<32 |
| XPSF8D3 | 1N | =<32 | =<31 |
| XPSF8E3 | 1N | =<32 | =<30 |
| XPSF8F3 | 1N | =<32 | =<29 |
| XPSF8A4 | 1N | =<31 | =<34 |
| XPSF8B4 | 1N | =<31 | =<33 |
| XPSF8C4 | 1N | =<31 | =<32 |
| XPSF8D4 | 1N | =<31 | =<31 |
| XPSF8E4 | 1N | =<31 | =<30 |
| XPSF8F4 | 1N | =<30 | =<29 |
| XPSF8A5 | 1N | =<30 | =<34 |
| XPSF8B5 | 1N | =<30 | =<33 |
| XPSF8C5 | 1N | =<30 | =<32 |
| XPSF8D5 | 1N | =<30 | =<31 |
| XPSF8E5 | 1N | =<30 | =<30 |
| XPSF8F5 | 1N | =<30 | =<29 |
| XPSF9A1 | 1O | =<34 | =<34 |
| XPSF9B1 | 1O | =<34 | =<33 |
| XPSF9C1 | 1O | =<34 | =<32 |
| XPSF9D1 | 1O | =<34 | =<31 |
| XPSF9E1 | 1O | =<34 | =<30 |
| XPSF9F1 | 1O | =<34 | =<29 |
| XPSF9A2 | 1O | =<33 | =<34 |
| XPSF9B2 | 1O | =<33 | =<33 |
| XPSF9C2 | 1O | =<33 | =<32 |
| XPSF9D2 | 1O | =<33 | =<31 |
| XPSF9E2 | 1O | =<33 | =<30 |
| XPSF9F2 | 1O | =<33 | =<29 |
| XPSF9A3 | 1O | =<32 | =<34 |
| XPSF9B3 | 1O | =<32 | =<33 |
| XPSF9C3 | 1O | =<32 | =<32 |
| XPSF9D3 | 1O | =<32 | =<31 |
| XPSF9E3 | 1O | =<32 | =<30 |
| XPSF9F3 | 1O | =<32 | =<29 |
| XPSF9A4 | 1O | =<31 | =<34 |
| XPSF9B4 | 1O | =<31 | =<33 |
| XPSF9C4 | 1O | =<31 | =<32 |
| XPSF9D4 | 1O | =<31 | =<31 |
| XPSF9E4 | 1O | =<31 | =<30 |
| XPSF9F4 | 1O | =<30 | =<29 |
| XPSF9A5 | 1O | =<30 | =<34 |
| XPSF9B5 | 1O | =<30 | =<33 |
| XPSF9C5 | 1O | =<30 | =<32 |
| XPSF9D5 | 1O | =<30 | =<31 |
| XPSF9E5 | 1O | =<30 | =<30 |
| XPSF9F5 | 1O | =<30 | =<29 |
| XPSF10A1 | 1T | =<33 | =<34 |
| XPSF10B1 | 1T | =<33 | =<33 |
| XPSF10C1 | 1T | =<33 | =<32 |
| XPSF10D1 | 1T | =<33 | =<31 |
| XPSF10E1 | 1T | =<33 | =<30 |
| XPSF10F1 | 1T | =<33 | =<29 |
| XPSF10A2 | 1T | =<32 | =<34 |
| XPSF10B2 | 1T | =<32 | =<33 |
| XPSF10C2 | 1T | =<32 | =<32 |
| XPSF10D2 | 1T | =<32 | =<31 |
| XPSF10E2 | 1T | =<32 | =<30 |
| XPSF10F2 | 1T | =<32 | =<29 |
| XPSF10A3 | 1T | =<31 | =<34 |
| XPSF10B3 | 1T | =<31 | =<33 |
| XPSF10C3 | 1T | =<31 | =<32 |
| XPSF10D3 | 1T | =<31 | =<31 |
| XPSF10E3 | 1T | =<31 | =<30 |
| XPSF10F3 | 1T | =<30 | =<29 |
| XPSF10A4 | 1T | =<30 | =<34 |
| XPSF10B4 | 1T | =<30 | =<33 |
| XPSF10C4 | 1T | =<30 | =<32 |
| XPSF10D4 | 1T | =<30 | =<31 |
| XPSF10E4 | 1T | =<30 | =<30 |
| XPSF10F4 | 1T | =<30 | =<29 |
| XPSF11A1 | 1U1 | =<32 | =<34 |
| XPSF11B1 | 1U1 | =<32 | =<33 |
| XPSF11C1 | 1U1 | =<32 | =<32 |
| XPSF11D1 | 1U1 | =<32 | =<31 |
| XPSF11E1 | 1U1 | =<32 | =<30 |
| XPSF11F1 | 1U1 | =<32 | =<29 |
| XPSF11A2 | 1U1 | =<31 | =<34 |
| XPSF11B2 | 1U1 | =<31 | =<33 |
| XPSF11C2 | 1U1 | =<31 | =<32 |
| XPSF11D2 | 1U1 | =<31 | =<31 |
| XPSF11E2 | 1U1 | =<31 | =<30 |
| XPSF11F2 | 1U1 | =<31 | =<29 |
| XPSF11A3 | 1U1 | =<30 | =<34 |
| XPSF11B3 | 1U1 | =<30 | =<33 |
| XPSF11C3 | 1U1 | =<30 | =<32 |
| XPSF11D3 | 1U1 | =<30 | =<31 |
| XPSF11E3 | 1U1 | =<30 | =<30 |
| XPSF11F3 | 1U1 | =<29 | =<29 |
| XPSF11A4 | 1U1 | =<29 | =<34 |
| XPSF11B4 | 1U1 | =<29 | =<33 |
| XPSF11C4 | 1U1 | =<29 | =<32 |
| XPSF11D4 | 1U1 | =<29 | =<31 |
| XPSF11E4 | 1U1 | =<29 | =<30 |
| XPSF11F4 | 1U1 | =<29 | =<29 |
| XPSF12A1 | 1U2 | =<32 | =<34 |
| XPSF12B1 | 1U2 | =<32 | =<33 |
| XPSF12C1 | 1U2 | =<32 | =<32 |
| XPSF12D1 | 1U2 | =<32 | =<31 |
| XPSF12E1 | 1U2 | =<32 | =<30 |
| XPSF12F1 | 1U2 | =<32 | =<29 |
| XPSF12A2 | 1U2 | =<31 | =<34 |
| XPSF12B2 | 1U2 | =<31 | =<33 |
| XPSF12C2 | 1U2 | =<31 | =<32 |
| XPSF12D2 | 1U2 | =<31 | =<31 |
| XPSF12E2 | 1U2 | =<31 | =<30 |
| XPSF12F2 | 1U2 | =<31 | =<29 |
| XPSF12A3 | 1U2 | =<30 | =<34 |
| XPSF12B3 | 1U2 | =<30 | =<33 |
| XPSF12C3 | 1U2 | =<30 | =<32 |
| XPSF12D3 | 1U2 | =<30 | =<31 |
| XPSF12E3 | 1U2 | =<30 | =<30 |
| XPSF13A1 | 1U3 | =<32 | =<34 |
| XPSF13B1 | 1U3 | =<32 | =<33 |
| XPSF13C1 | 1U3 | =<32 | =<32 |
| XPSF13D1 | 1U3 | =<32 | =<31 |
| XPSF13E1 | 1U3 | =<32 | =<30 |
| XPSF13F1 | 1U3 | =<32 | =<29 |
| XPSF13A2 | 1U3 | =<31 | =<34 |
| XPSF13B2 | 1U3 | =<31 | =<33 |
| XPSF13C2 | 1U3 | =<31 | =<32 |
| XPSF13D2 | 1U3 | =<31 | =<31 |
| XPSF13E2 | 1U3 | =<31 | =<30 |
| XPSF13F2 | 1U3 | =<31 | =<29 |
| XPSF13A3 | 1U3 | =<30 | =<34 |
| XPSF13B3 | 1U3 | =<30 | =<33 |
| XPSF13C3 | 1U3 | =<30 | =<32 |
| XPSF13D3 | 1U3 | =<30 | =<31 |
| XPSF13E3 | 1U3 | =<30 | =<30 |
| XPSF14A1 | 1V | =<34 | =<34 |
| XPSF14B1 | 1V | =<34 | =<33 |
| XPSF14C1 | 1V | =<34 | =<32 |
| XPSF14D1 | 1V | =<34 | =<31 |
| XPSF14E1 | 1V | =<34 | =<30 |
| XPSF14F1 | 1V | =<34 | =<29 |
| XPSF14A2 | 1V | =<33 | =<34 |
| XPSF14B2 | 1V | =<33 | =<33 |
| XPSF14C2 | 1V | =<33 | =<32 |
| XPSF14D2 | 1V | =<33 | =<31 |
| XPSF14E2 | 1V | =<33 | =<30 |
| XPSF14F2 | 1V | =<33 | =<29 |
| XPSF14A3 | 1V | =<32 | =<34 |
| XPSF14B3 | 1V | =<32 | =<33 |
| XPSF14C3 | 1V | =<32 | =<32 |
| XPSF14D3 | 1V | =<32 | =<31 |
| XPSF14E3 | 1V | =<32 | =<30 |
| XPSF14F3 | 1V | =<32 | =<29 |
| XPSF14A4 | 1V | =<31 | =<34 |
| XPSF14B4 | 1V | =<31 | =<33 |
| XPSF14C4 | 1V | =<31 | =<32 |
| XPSF14D4 | 1V | =<31 | =<31 |
| XPSF14E4 | 1V | =<31 | =<30 |
| XPSF14F4 | 1V | =<30 | =<29 |
| XPSF14A5 | 1V | =<30 | =<34 |
| XPSF14B5 | 1V | =<30 | =<33 |
| XPSF14C5 | 1V | =<30 | =<32 |
| XPSF14D5 | 1V | =<30 | =<31 |
| XPSF14E5 | 1V | =<30 | =<30 |
| XPSF14F5 | 1V | =<30 | =<29 |
| XPSF15A1 | 1W1 | =<32 | =<34 |
| XPSF15B1 | 1W1 | =<32 | =<33 |
| XPSF15C1 | 1W1 | =<32 | =<32 |
| XPSF15D1 | 1W1 | =<32 | =<31 |
| XPSF15E1 | 1W1 | =<32 | =<30 |
| XPSF15F1 | 1W1 | =<32 | =<29 |
| XPSF15A2 | 1W1 | =<31 | =<34 |
| XPSF15B2 | 1W1 | =<31 | =<33 |
| XPSF15C2 | 1W1 | =<31 | =<32 |
| XPSF15D2 | 1W1 | =<31 | =<31 |
| XPSF15E2 | 1W1 | =<31 | =<30 |
| XPSF15F2 | 1W1 | =<31 | =<29 |
| XPSF15A3 | 1W1 | =<30 | =<34 |
| XPSF15B3 | 1W1 | =<30 | =<33 |
| XPSF15C3 | 1W1 | =<30 | =<32 |
| XPSF15D3 | 1W1 | =<30 | =<31 |
| XPSF15E3 | 1W1 | =<30 | =<30 |
| XPSF16A2 | 1W2 | =<33 | =<34 |
| XPSF16B2 | 1W2 | =<33 | =<33 |
| XPSF16C2 | 1W2 | =<33 | =<32 |
| XPSF16D2 | 1W2 | =<33 | =<31 |
| XPSF16E2 | 1W2 | =<33 | =<30 |
| XPSF16F2 | 1W2 | =<33 | =<29 |
| XPSF16A3 | 1W2 | =<32 | =<34 |
| XPSF16B3 | 1W2 | =<32 | =<33 |
| XPSF16C3 | 1W2 | =<32 | =<32 |
| XPSF16D3 | 1W2 | =<32 | =<31 |
| XPSF16E3 | 1W2 | =<32 | =<30 |
| XPSF16F3 | 1W2 | =<32 | =<29 |
| XPSF16A4 | 1W2 | =<31 | =<34 |
| XPSF16B4 | 1W2 | =<31 | =<33 |
| XPSF16C4 | 1W2 | =<31 | =<32 |
| XPSF16D4 | 1W2 | =<31 | =<31 |
| XPSF16E4 | 1W2 | =<31 | =<30 |
| XPSF16F4 | 1W2 | =<30 | =<29 |
| XPSF16A5 | 1W2 | =<30 | =<34 |
| XPSF16B5 | 1W2 | =<30 | =<33 |
| XPSF16C5 | 1W2 | =<30 | =<32 |
| XPSF16D5 | 1W2 | =<30 | =<31 |
| XPSF16E5 | 1W2 | =<30 | =<30 |
| XPSF16F5 | 1W2 | =<30 | =<29 |
| XPSF17A1 | 1W3 | =<32 | =<34 |
| XPSF17B1 | 1W3 | =<32 | =<33 |
| XPSF17C1 | 1W3 | =<32 | =<32 |
| XPSF17D1 | 1W3 | =<32 | =<31 |
| XPSF17E1 | 1W3 | =<32 | =<30 |
| XPSF17F1 | 1W3 | =<32 | =<29 |
| XPSF17A2 | 1W3 | =<31 | =<34 |
| XPSF17B2 | 1W3 | =<31 | =<33 |
| XPSF17C2 | 1W3 | =<31 | =<32 |
| XPSF17D2 | 1W3 | =<31 | =<31 |
| XPSF17E2 | 1W3 | =<31 | =<30 |
| XPSF17F2 | 1W3 | =<31 | =<29 |
| XPSF17A3 | 1W3 | =<30 | =<34 |
| XPSF17B3 | 1W3 | =<30 | =<33 |
| XPSF17C3 | 1W3 | =<30 | =<32 |
| XPSF17D3 | 1W3 | =<30 | =<31 |
| XPSF17E3 | 1W3 | =<30 | =<30 |
| XPSF18A1 | 1X1 | =<32 | =<34 |
| XPSF18B1 | 1X1 | =<32 | =<33 |
| XPSF18C1 | 1X1 | =<32 | =<32 |
| XPSF18D1 | 1X1 | =<32 | =<31 |
| XPSF18E1 | 1X1 | =<32 | =<30 |
| XPSF18F1 | 1X1 | =<32 | =<29 |
| XPSF18A2 | 1X1 | =<31 | =<34 |
| XPSF18B2 | 1X1 | =<31 | =<33 |
| XPSF18C2 | 1X1 | =<31 | =<32 |
| XPSF18D2 | 1X1 | =<31 | =<31 |
| XPSF18E2 | 1X1 | =<31 | =<30 |
| XPSF18F2 | 1X1 | =<31 | =<29 |
| XPSF18A3 | 1X1 | =<30 | =<34 |
| XPSF18B3 | 1X1 | =<30 | =<33 |
| XPSF18C3 | 1X1 | =<30 | =<32 |
| XPSF18D3 | 1X1 | =<30 | =<31 |
| XPSF18E3 | 1X1 | =<30 | =<30 |
| XPSF19A1 | 1X2 | =<32 | =<34 |
| XPSF19B1 | 1X2 | =<32 | =<33 |
| XPSF19C1 | 1X2 | =<32 | =<32 |
| XPSF19D1 | 1X2 | =<32 | =<31 |
| XPSF19E1 | 1X2 | =<32 | =<30 |
| XPSF19F1 | 1X2 | =<32 | =<29 |
| XPSF19A2 | 1X2 | =<31 | =<34 |
| XPSF19B2 | 1X2 | =<31 | =<33 |
| XPSF19C2 | 1X2 | =<31 | =<32 |
| XPSF19D2 | 1X2 | =<31 | =<31 |
| XPSF19E2 | 1X2 | =<31 | =<30 |
| XPSF19F2 | 1X2 | =<31 | =<29 |
| XPSF19A3 | 1X2 | =<30 | =<34 |
| XPSF19B3 | 1X2 | =<30 | =<33 |
| XPSF19C3 | 1X2 | =<30 | =<32 |
| XPSF19D3 | 1X2 | =<30 | =<31 |
| XPSF19E3 | 1X2 | =<30 | =<30 |

In preferred embodiments, for each of the foams in the Foam XPS Table above having a density value indicated as being equal to or below an indicated density, the foam has a density of greater than 25 kg/m³, or of greater than 26 kg/m³, or of greater than 27 kg/m³, or of greater than 28 kg/m³.

In preferred embodiments, for each of the foams in the Foam XPS Table above having an aged lambda value indicated as being equal to or below an indicated aged lambda, the foam has an aged lambda of greater than 25 mW/mK, or of greater than 26 mW/mK, or of greater than 27 mW/mK, or of greater than 28 mW/mK.

The present invention includes XPS foam including each of Foams 1-4, wherein the foam has a density of 34 kg/m³ or less and aged thermal conductivity of 32 mW/mk or less. For the purposes of convenience, foams in accordance with this paragraph are referred to herein as Foam 5A.

The present invention includes XPS foam, including each of Foams 1-4, wherein the foam has a density of 33 kg/m³ or less and aged thermal conductivity of 31 mW/mk or less. For the purposes of convenience, foams in accordance with this paragraph are referred to herein as Foam 5B.

The present invention includes XPS foam, including each of Foams 1-4, wherein the foam has a density of 32 kg/m³ or less and aged thermal conductivity of 31 mW/mk or less. For the purposes of convenience, foams in accordance with this paragraph are referred to herein as Foam 5C.

The present invention includes XPS foam, including each of Foams 1-4, wherein the foam has a density of 31 kg/m³ or less and aged thermal conductivity of 31 mW/mk or less. For the purposes of convenience, foams in accordance with this paragraph are referred to herein as Foam 5D.

The present invention includes XPS foam, including each of Foams 1-4, wherein the foam has a density of 31 kg/m³ or less and aged thermal conductivity of 30 mW/mk or less. For the purposes of convenience, foams in accordance with this paragraph are referred to herein as Foam 5E.

The present invention includes XPS foam, including each of Foams 1-4, wherein the foam has a density of 31 kg/m³ or less and aged thermal conductivity of 29 mW/mk or less. For the purposes of convenience, foams in accordance with this paragraph are referred to herein as Foam 5F.

The present invention includes XPS foam, including each of Foams 1-4, wherein the foam has a density of 30 kg/m³ or less and aged thermal conductivity of 30 mW/mk or less. For the purposes of convenience, foams in accordance with this paragraph are referred to herein as Foam 5G.

The present invention includes XPS foam, including each of Foams 1-4, wherein the foam has a density of 30 kg/m³ or less and aged thermal conductivity of 29 mW/mk or less. For the purposes of convenience, foams in accordance with this paragraph are referred to herein as Foam 5H.

The present invention includes XPS foam, including each of Foams 1-10, wherein the foam is a closed cell foam. For the purposes of convenience, foams in accordance with this paragraph are referred to herein as Foam 5I.

The present invention includes XPS foam, including each of Foams 1-10, wherein the foam is a closed cell foam having at least 50% by volume of closed cells. For the purposes of convenience, foams in accordance with this paragraph are referred to herein as Foam 5J.

The present invention includes XPS foam, including each of Foams 1-10, wherein the foam is a closed cell foam having at least 90% by volume of closed cells. For the purposes of convenience, foams in accordance with this paragraph are referred to herein as Foam 5K.

The styrene resin for use in the present invention, including each of the foams identified in the XPS FOAM TABLE above, in each of Foams 1-5 and each of Methods 1-10, is not particularly limited and examples of the styrene resin include homopolymers of styrene monomers such as styrene, methylstyrene, ethylstyrene, isopropylstyrene, dimethylstyrene, bromostyrene, chlorostyrene, vinyltoluene, and vinylxylene, or copolymers of two or more of the monomers, copolymers obtained by copolymerization of the styrene monomer with at least one or two or more of monomers such as divinylbenzene, butadiene, acrylic acid, methacrylic acid, methyl acrylate, methyl methacrylate, acrylonitrile, maleic anhydride, and itaconic anhydride, and the like. The monomers to be copolymerized with the styrene monomer, such as acrylic acid, methacrylic acid, methyl acrylate, methyl methacrylate, maleic anhydride, and itaconic anhydride, can be used with such an amount that the physical properties, such as compressive strength, of the extruded polystyrene foam to be produced are not impaired. The styrene resin for use in the present invention is not limited to the homopolymers or the copolymers of the styrene monomers and may be a blend of the homopolymers or the copolymers of the styrene monomers and the homopolymers or the copolymers of the other monomers, and a diene rubber reinforced polystyrene or an acrylic rubber reinforced polystyrene can be blended. The styrene resin for use in the present invention may be a styrene resin having a branched structure for the purpose of adjusting the melt volume rate (hereinafter also referred to as MVR), a melt viscosity and a melt tension in molding, and the like.

According to preferred embodiments, the foams of the present invention, including each of the foams identified in the XPS FOAM TABLE above and in each of Foams 1-5, are formed from a general purpose styrene resin, preferably having an MVR of 0.1 to 50 g/10 minutes. Such resins are preferably used in the respect that a thermoplastic resin foam in which the moldability in extrusion foam molding is excellent, the discharge amount in molding, the thickness and the width and the apparent density or the closed cell ratio of the obtained extruded polystyrene foam can be adjusted to desired values. The MVR of the styrene resin can include from 0.3 to 30 g/10 minutes, or 0.5 to 25 g/10. In the present invention, the MVR is measured by ISO 1133.

In the present invention, among the styrene resin mentioned above, polystyrene resin is suitable in the respect of economical efficiency and processability. When higher heat resistance is required in an extruded foam, it is preferable to use a styrene-acrylonitrile copolymer, (meth)acrylic acid-copolymerized polystyrene, maleic anhydride-modified polystyrene. When a higher impact resistance is demanded in an extruded foam, it is preferable to use rubber-reinforced polystyrene. The styrene resin may be used alone or two or more kinds of styrene resin different in a copolymerization component, a molecular weight and a molecular weight distribution, a branched structure, an MVR, and the like may be used as a mixture.

The PS used to form the present foams, including the foams identified in the XPS FOAM TABLE above and in each of each of Foams 1-5, and which is used in accordance with the present methods, including each of Methods 1-10, can have properties within each of the broad, intermediate and narrow ranges identified in the following table:

| | Broad | Intermediate | Narrow |
|---|---|---|---|
| | Range | Range | Range |
| Polymer | | | |
| property, | | | |
| Melt Volume | 0.1-50 | 10-40 | 15-30 |
| Rate, ISO 1133 | | | |
| (cm3/10 min.) | | | |
| Vicat Softening | 90-115 | 95-110 | 95-105 |
| Temperature | | | |
| VST/B/50 (50N, | | | |
| 50° C./h) | | | |
| Melting | 100-350 | 150-300 | 180-280 |
| Temperature, | | | |
| Tm, ° C. | | | |

Methods

Applicants have found that unexpected advantages can be achieved with respect to the preparation of thermoplastic foams, including the foams identified in the XPS FOAM TABLE above and in each of each of Foam 1-Foam 5, by using a blowing agent of the present invention in the foam forming process.

In particular aspects, the present invention includes method for making thermoplastic XPS foam comprising:

(i) providing PS; and

(ii) foaming the PS using any one of the blowing agents of the present invention, including each of Blowing Agent 1 through Blowing Agent 4. For the purposes of convenience, methods in accordance with this paragraph are referred to herein as Method 1.

The present invention also provides methods for forming extruded thermoplastic foam comprising:

(i) providing a thermoplastic material;

(ii) extruding the thermoplastic material; and

(iii) foaming the thermoplastic material using any one of the blowing agents of the present invention, including each of Blowing Agent 1 through Blowing Agent 4. For the purposes of convenience, methods in accordance with this paragraph are referred to herein as Method 2.

The present invention also provides methods for forming XPS comprising:

(i) providing a thermoplastic polystyrene;

(ii) extruding the thermoplastic polystyrene; and

(iii) foaming a polystyrene foam using any one of the blowing agents of the present invention, including each of Blowing Agent 1 through Blowing Agent 4. For the purposes of convenience, methods in accordance with this paragraph are referred to herein as Method 3.

The present invention also provides methods for making XPS foams comprising:

(i) providing PS; and

(ii) foaming the PS using any one of the blowing agents of the present invention, including each of Blowing Agent 1 through Blowing Agent 4, wherein the foam has a density of about 33 kg/m3 or less and an aged thermal conductivity of 32 mW/mk or less. For the purposes of convenience, methods in accordance with this paragraph are referred to herein as Method 4A.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of of about 33 kg/m3 or less and an aged thermal conductivity of 31 mW/mk or less. For the purposes of convenience, methods in accordance with this paragraph are referred to herein as Method 4B.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 33 kg/m3 or less and an aged thermal conductivity of 30 mW/mk or less. For the purposes of convenience, methods in accordance with this paragraph are referred to herein as Method 4C.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 33 kg/m3 or less and an aged thermal conductivity of 29 mW/mk or less. For the purposes of convenience, methods in accordance with this paragraph are referred to herein as Method 4D.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 33 kg/m3 or less and an aged thermal conductivity of 28 mW/mk or less. For the purposes of convenience, methods in accordance with this paragraph are referred to herein as Method 4E.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 32 kg/m3 or less and an aged thermal conductivity of 32 mW/mk or less. For the purposes of convenience, methods in accordance with this paragraph are referred to herein as Method 4F.

The present invention also provides methods for making XPS foams comprising:

(i) providing PS; and

(ii) foaming the PS using any one of the blowing agents of the present invention, including each of Blowing Agent 1 through Blowing Agent 4, wherein the foam has a density of of about 32 kg/m3 or less and an aged thermal conductivity of 31 mW/mk or less. For the purposes of convenience, methods in accordance with this paragraph are referred to herein as Method 4G.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 32 kg/m3 or less and an aged thermal conductivity of 30 mW/mk or less. For the purposes of convenience, methods in accordance with this paragraph are referred to herein as Method 4H.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 32 kg/m3 or less and an aged thermal conductivity of 29 mW/mk or less. For the purposes of convenience, methods in accordance with this paragraph are referred to herein as Method 41.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of less about 32 kg/m3 and an aged thermal conductivity of 28 mW/mk or less. For the purposes of convenience, methods in accordance with this paragraph are referred to herein as Method 4J.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 31 kg/m3 or less and an aged thermal conductivity of 32 mW/mk or less. For the purposes of convenience, methods in accordance with this paragraph are referred to herein as Method 4K.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 31 kg/m3 or less and an aged thermal conductivity of 31 mW/mk or less. For the purposes of convenience, methods in accordance with this paragraph are referred to herein as Method 4L.

The present invention also provides methods for making XPS foams comprising:

(i) providing PS; and

(ii) foaming the PS using any one of the blowing agents of the present invention, including each of Blowing Agent 1 through Blowing Agent 4, wherein the foam has a density of about 31 kg/m3 or less and an aged thermal conductivity of 29 mW/mk or less. For the purposes of convenience, methods in accordance with this paragraph are referred to herein as Method 4M.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 31 kg/m3 or less and an aged thermal conductivity of 28 mW/mk or less. For the purposes of convenience, methods in accordance with this paragraph are referred to herein as Method 4N.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 30 kg/m3 or less and an aged thermal conductivity of 32 mW/mk or less. For the purposes of convenience, methods in accordance with this paragraph are referred to herein as Method 40.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of less about 30 kg/m3 and an aged thermal conductivity of 31 mW/mk or less. For the purposes of convenience, methods in accordance with this paragraph are referred to herein as Method 4P.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 30 kg/m3 or less and an aged thermal conductivity of 30 mW/mk or less. For the purposes of convenience, methods in accordance with this paragraph are referred to herein as Method 40.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 4, wherein the foam has a density of about 30 kg/m3 or less and an aged thermal conductivity of 29 mW/mk or less. For the purposes of convenience, methods in accordance with this paragraph are referred to herein as Method 4R.

The present invention also provides methods for making thermoplastic foams, including each of Method 1 through Method 6 wherein said blowing agent is used in an amount of from about 4 parts per hundred of thermoplastic resin material (hereinafter “pph” or “pphr”) to about 10 pphr. For the purposes of convenience, methods in accordance with this paragraph are referred to herein as Method 5.

The present invention also provides methods for making thermoplastic foams, including each of Method 1 through Method 4, wherein said blowing agent is used in an amount of from about 5 pphr to about 9 pphr. For the purposes of convenience, methods in accordance with this paragraph are referred to herein as Method 6A.

The present invention also provides methods for making thermoplastic foams, including each of Method 1 through Method 4, wherein said blowing agent is used in an amount of from about 5 pphr to about 8 pphr. For the purposes of convenience, methods in accordance with this paragraph are referred to herein as Method 6B.

The present invention also provides methods for making thermoplastic foams, including each of Method 1 through Method 4, wherein said blowing agent is used in an amount of from about 5 pphr to less than about 8 pphr. For the purposes of convenience, methods in accordance with this paragraph are referred to herein as Method 6C.

The present invention also provides methods for making thermoplastic foams, including each of Method 1 through Method 4, wherein said blowing agent is used in an amount of from 6 pphr to 10 pphr. For the purposes of convenience, methods in accordance with this paragraph are referred to herein as Method 7.

The present invention also provides methods for making thermoplastic foams, including each of Method 1 through Method 4, wherein said blowing agent is used in an amount of from about 6 pphr to about 9 pphr. For the purposes of convenience, methods in accordance with this paragraph are referred to herein as Method 8.

The present invention also provides methods for making thermoplastic foams, including each of Method 1 through Method 4, wherein said blowing agent is used in an amount of about 7 pphr. For the purposes of convenience, methods in accordance with this paragraph are referred to herein as Method 9.

The present invention also provides methods for making thermoplastic foams, including each of Method 1 through Method 9, wherein said step of providing said thermoplastic material or PS comprises including in said thermoplastic material one or more optional components selected from surfactants, polymer modifiers, toughening agents, colorants, dyes, solubility enhancers, rheology modifiers, plasticizing agents, flammability suppressants, antimicrobial agents, viscosity reduction modifiers, fillers, vapor pressure modifiers, nucleating agents, catalysts and the like. For the purposes of convenience, methods in accordance with this paragraph are referred to herein as Method 10.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 10 pph;

(ii) extruding the melt; and

(iii) foaming the melt to form an extruded polystyrene foam having a density of from about 25 kg/m³ to less than about 34 kg/m³ and an aged thermal conductivity of from about 25 mW/mk to less than about 34 mW/mk or less. For the purposes of convenience, methods in accordance with this paragraph are referred to herein as Method 11A.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 33 kg/m³ and an aged thermal conductivity of from about 25 mW/mk to less than about 33 mW/mk or less. For the purposes of convenience, methods in accordance with this paragraph are referred to herein as Method 11B.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 32 kg/m³ and an aged thermal conductivity of from about 25 mW/mk to less than about 32 mW/mk or less. For the purposes of convenience, methods in accordance with this paragraph are referred to herein as Method 11C.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 31 kg/m³ and an aged thermal conductivity of from about 25 mW/mk to less than about 32 mW/mk or less. For the purposes of convenience, methods in accordance with this paragraph are referred to herein as Method 11 D.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 30 kg/m³ and an aged thermal conductivity of from about 25 mW/mk to less than about 32 mW/mk or less. For the purposes of convenience, methods in accordance with this paragraph are referred to herein as Method 11E.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 30 kg/m³ and an aged thermal conductivity of from about 25 mW/mk to less than about 31 mW/mk or less. For the purposes of convenience, methods in accordance with this paragraph are referred to herein as Method 11F.

The present invention also provides methods for forming extruded thermoplastic foam comprising:

(i) providing a melt comprising, or consisting essentially of, polystyrene and a blowing agent, including each of Blowing Agents 1-5, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 30 kg/m³ and an aged thermal conductivity of from about 25 mW/mk to less than about 30 mW/mk or less. For the purposes of convenience, methods in accordance with this paragraph are referred to herein as Method 11G.

The present invention also provides methods for forming extruded thermoplastic foam comprising:

(i) providing a melt comprising, or consisting essentially of, polystyrene and Blowing Agent 1K1, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 32 kg/m³ and an aged thermal conductivity of from about 25 mW/mk to less than about 33 mW/mk or less. For the purposes of convenience, methods in accordance with this paragraph are referred to herein as Method 11H.

The present invention also provides methods for forming extruded thermoplastic foam comprising:

(i) providing a melt comprising, or consisting essentially of, polystyrene and Blowing Agent 1K1, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to less than 32 kg/m³ and an aged thermal conductivity of from about 25 mW/mk to less than 30 mW/mk or less. For the purposes of convenience, methods in accordance with this paragraph are referred to herein as Method 11I.

The present invention also provides methods for forming extruded thermoplastic foam comprising:

(i) providing a melt comprising, or consisting essentially of, polystyrene and Blowing Agent 1K1, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to not greater than 31.5 kg/m³ and an aged thermal conductivity of from about 25 mW/mk to less than 30 mW/mk or less. For the purposes of convenience, methods in accordance with this paragraph are referred to herein as Method 11J.

The present invention also provides methods for forming extruded thermoplastic foam comprising:

(i) providing a melt comprising, or consisting essentially of, polystyrene and Blowing Agent 1K1, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to not greater than 30 kg/m³ and an aged thermal conductivity of from about 25 mW/mk to not greater than 30 mW/mk. For the purposes of convenience, methods in accordance with this paragraph are referred to herein as Method 11K.

The present invention also provides methods for forming extruded thermoplastic foam comprising:

(i) providing a melt comprising, or consisting essentially of, polystyrene and Blowing Agent 1K2, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 32 kg/m³ and an aged thermal conductivity of from about 25 mW/mk to less than about 33 mW/mk or less. For the purposes of convenience, methods in accordance with this paragraph are referred to herein as Method 11L.

The present invention also provides methods for forming extruded thermoplastic foam comprising:

(i) providing a melt comprising, or consisting essentially of, polystyrene and Blowing Agent 1K2, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to less than 32 kg/m³ and an aged thermal conductivity of from about 25 mW/mk to less than 30 mW/mk or less. For the purposes of convenience, methods in accordance with this paragraph are referred to herein as Method 11M.

The present invention also provides methods for forming extruded thermoplastic foam comprising:

(i) providing a melt comprising, or consisting essentially of, polystyrene and Blowing Agent 1K2, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to not greater than 31.5 kg/m³ and an aged thermal conductivity of from about 25 mW/mk to less than 30 mW/mk or less. For the purposes of convenience, methods in accordance with this paragraph are referred to herein as Method 11N.

The present invention also provides methods for forming extruded thermoplastic foam comprising:

(i) providing a melt comprising, or consisting essentially of, polystyrene and Blowing Agent 1K2, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to not greater than 30 kg/m³ and an aged thermal conductivity of from about 25 mW/mk to not greater than 30 mW/mk. For the purposes of convenience, methods in accordance with this paragraph are referred to herein as Method 11O.

The present invention also provides methods for forming extruded thermoplastic foam comprising:

(i) providing a melt comprising, or consisting essentially of, polystyrene and Blowing Agent 1L, wherein the amount of said blowing agent is present in the melt in an amount of from about 5 pph to less than 9 pph;

(ii) extruding the melt; and

(iii) foaming the melt to form an extruded polystyrene foam having a density of from about 25 kg/m³ to less than about 32 kg/m³ and an aged thermal conductivity of from about 25 mW/mk to less than about 33 mW/mk or less. For the purposes of convenience, methods in accordance with this paragraph are referred to herein as Method 11P.

The present invention also provides methods for forming extruded thermoplastic foam comprising:

(i) providing a melt comprising, or consisting essentially of, polystyrene and Blowing Agent 1L, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to less than 32 kg/m³ and an aged thermal conductivity of from about 25 mW/mk to less than 30 mW/mk or less. For the purposes of convenience, methods in accordance with this paragraph are referred to herein as Method 11Q.

The present invention also provides methods for forming extruded thermoplastic foam comprising:

(i) providing a melt comprising, or consisting essentially of, polystyrene and Blowing Agent 1L, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to not greater than 31.5 kg/m³ and an aged thermal conductivity of from about 25 mW/mk to less than 30 mW/mk or less. For the purposes of convenience, methods in accordance with this paragraph are referred to herein as Method 11R.

The present invention also provides methods for forming extruded thermoplastic foam comprising:

(i) providing a melt comprising, or consisting essentially of, polystyrene and Blowing Agent 1L, wherein the amount of said blowing agent is present in the melt in an amount of from about 5 pph to less than 8.5 pph;

(ii) extruding the melt; and

(iii) foaming the melt to form an extruded polystyrene foam having a density of from about 25 kg/m³ to not greater than 30 kg/m³ and an aged thermal conductivity of from about 25 mW/mk to not greater than 30 mW/mk. For the purposes of convenience, methods in accordance with this paragraph are referred to herein as Method 11S.

The methods of the present invention, including each of Methods 1-10, can be formed from any PS resin, including general purpose styrene resin, preferably having an MVR of 0.1 to 50 g/10 minutes, more preferably of from 10 to 40 g/10 minutes, more preferably from 10 to 30 g/10 minutes.

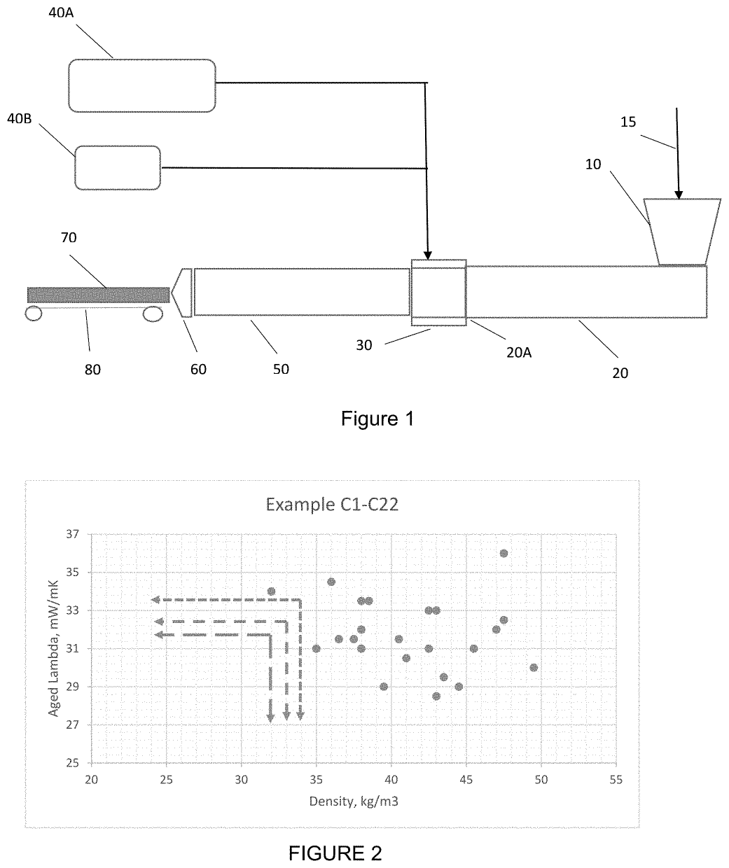

The methods can be carried out, by way of example, using extrusion equipment of the general type disclosed in FIG. 1, which is described below in more detail below in connection with the examples. It will be appreciated that while FIG. 1 shows only a single feed point for introducing blowing agent into the extrusion process, the use of multiple feed points to introduce the blowing agent may be used. Furthermore, it will be appreciated that the term “blowing agent” as used herein, including each of Blowing Agents 1-4, includes not only the defined set of components introduced into the extruder when there is a single introduction point, but also the aggregate combination of components that may be introduced at plural points into the extrusion or other foaming equipment.

### EXAMPLES

The following examples are provided for the purpose of illustrating the present invention but without limiting the scope thereof.

The examples utilized an extrusion apparatus substantially as illustrated in FIG. 1. In particular, the apparatus included a raw material feed hopper 10 for holding polystyrene feed material 15, together with any optional components (which may be added with the polystyrene or optionally elsewhere in the process depending on the particular needs of the user). In the case of the examples hereof, the polystyrene feed is in the form of general purpose polystyrene pellets sold by Ineos under the trade designation Styrolution 156F and having the following properties:

| Property, | | | |
|---|---|---|---|
| Test | | | |
| Condition | Standard | Unit | Values |
| Melt Volume Rate, | ISO 1133 | cm³/10 min | 28 |
| 200° C./5 kg | | | |
| Vicat Softening | ISO 306 | ° C. | 101 |
| Temperature | | | |
| VST/B/50 (50N, | | | |
| 50° C./h) | | | |
| Melt Temperature | ISO 294 | ° C. | 180-280 |
| Range | | | |

The feed material also included the flame retardant sold under the trade designation Apryos 5PB12HT, the nucleating agent (GRANIC 2281) and processing aid (Zinc Stearate). The total of the raw material feed stream 15 used to form the foam and introduced into the single screw extruder 20 are based on the following concentrations of components:

| Component | pph |
|---|---|
| polystyrene (Styrolution 156F) | 100 |
| Copolymer (Low density | 0.3 |
| polyethylene - PE 003 from | |
| Repsol) | |
| flame retardants (Apyros | 2 |
| 5PB12HT) | |
| nucleating agent (GRANIC 2281 - | 0.8 |
| talc) | |
| processing aid (Zinc Stearate) | 0.8 |
| Blowing agent (total of all co- | 5.2-9 |
| blowing agents) | |

The feed materials 15, excluding the blowing agent, were charged to the hopper and delivered to the screw extruder 10 at a nominal rate of about 3.3 kilograms per hour and the screw operated with at a nominal 85 rpm. The extruder 20 had thermocouples (not shown) located at three points along the length thereof and a pressure sensor (not shown) at the discharge end 20A of the extruder. A mixer section 30 was located at the discharge end 20A of the extruder for receiving blowing agent components via one or more metering pumps 40A and 40B and mixing those blowing agents into the polystyrene melt in the mixer section. Sensors (not shown) were included for monitoring the temperature and pressure of the mixer section 30. The mixer section 30 discharged the melt with the blowing agent into a pair of melt coolers 50 oriented in series, with temperature sensors (not shown) located in each cooler to monitor the melt temperature. The melt was then extruded through a die 60 which also had temperature and pressure sensors (not shown) for monitoring the pressure and temperature at the die. The die pressure was varied from 70 to 100 bars to minimize the density for each blowing agent tested and the die temperature was kept at 128° C. Exiting the die was a foamed sheet of polystyrene 70 which is carried away from the extrusion equipment by a conveyor belt 80.

The equipment illustrated in FIG. 1 and described above was used for each of the experimental tests described in the examples below to form a foam. After the foam is formed, the density and aged thermal conductivity (also referred to as “aged lambda”) were measured. The aged lambda values were measured according to ISO 11561:199 (providing similar results as European Standard BS EN 13164:2012+A1:2015), modified in accordance with the description proved below:

Day 0—the foam is extruded

Day 1—initial thermal conductivity of the block (skins, 120×120 mm, thickness of 15-20 mm) is determined at 10° C.+/−2° C.

Day 4—slicing of the block into 6 mm thick slices is performed (with skins removed) to obtain one slice per extruded sample that is 23 mm wide and 120 mm long and then at least 4 slices are stacked; thermal conductivity of the stack is measured at 10° C.+/−2° C. and then the slices are separated and kept at about 23° C. and 50% relative humidity.

Days 6-36—the procedure of Day 4 is repeated every two or three days until about 28 days is reached to obtain aged thermal conductivity by Method A, which comprises plotting the lambda values against time and then calculating aged thermal conductivity (λaged).

### Comparative Examples C1-C23—XPS Foam

Twenty three (23) extruded polystyrene foams were produced using the equipment and materials described above and illustrated in FIG. 1. All of the foams were prepared using the same raw materials except a different blowing agent was used in each case, as indicated in Table C1-C23 below. In each case, the die pressure which minimized the foam density was determined and used to produce the foam.

After the foam was formed, the density and aged thermal conductivity (also referred to as “aged lambda”) were measured in accordance with the descriptions above. The results are reported in Table C1-C23 below.

TABLE C1-C23

| | | | | Blowing Agent | | | | Aged |
|---|---|---|---|---|---|---|---|---|
| | Blowing Agent | | | Components, wt % in | | | Density · | Lambda, |
| Ex | Components, wt % in melt | | | Blowing Agent | | | kg/m³ | mW/mK |
| C1 | 3.2% | 2.8% | | 53.3% | 46.7% | | 31-33 | 34 |
| | CO2 | EtOH | | CO2 | EtOH | | | |
| C2 | 3% | 2.2% | | 57.7% | 42.3% | | 35-37 | 34.5 |
| | CO2 | EtOH | | CO2 | EtOH | | | |
| C3 | 4% | 3.4% | | 54% | 46% | | 40.5 | 31.5 |
| | 1234ze(E) | EtOH | | 1234ze(E) | EtOH | | | |
| C4 | 3.5% | 3.5% | | 50% | 50% | | 43 | 33 |
| | 1234ze(E) | EtOH | | 1234ze(E) | EtOH | | | |
| C5 | 3% | 3.5% | | 46.2% | 53.8% | | 42.5 | 33 |
| | 1234ze(E) | EtOH | | 1234ze(E) | EtOH | | | |
| C6 | 3% | 3.5% | 1% | 40% | 46.7% | 13.3% | 38 | 33.5 |
| | 1234ze(E) | EtOH | CO2 | 1234ze(E) | EtOH | CO2 | | |
| C7 | 3.5% | 3% | 1% | 46.7% | 40% | 13.3% | 38.5 | 33.5 |
| | 1234ze(E) | EtOH | CO2 | 1234ze(E) | EtOH | CO2 | | |
| C8 | 7% | 2% | | 77.8% | 22.2% | | 47 | 32 |
| | 1234ze(E) | EtOH | | 1234ze(E) | EtOH | | | |
| C9 | 4% | 3.5% | | 53.3% | 46.7% | | 47.6 | 36 |
| | 1234ze(E) | EtOH | | 1234ze(E) | EtOH | | | |
| C10 | 4% | 3.5% | 1% | 47% | 41% | 12% | 38 | 31 |
| | 1234ze(E) | Acetone | CO2 | 1234ze(E) | Acetone | CO2 | | |
| C11 | 4% | 3.5% | 1% | 47% | 41% | 12% | 42.5 | 31 |
| | 1234ze(E) | CycloC6 | CO2 | 1234ze(E) | Acetone | CO2 | | |
| C12 | 4% | | 2% | 66.7% | | 66.7% | 47.5 | 32.5 |
| | 1233zd(E) | | CO2 | 1233zd(E) | | CO2 | | |
| C13 | 1% | 3% | 2% | 16.7% | 50% | 33.3% | 45.5 | 31 |
| | 1234ze(E) | 1233zd(E) | CO2 | 1234ze(E) | 1233zd(E) | CO2 | | |
| C14 | 2% | 2% | 1.5% | 36.4% | 36.4% | 27.3% | 49.5 | 30 |
| | 1234ze(E) | 1233zd(E) | CO2 | 1234ze(E) | 1233zd(E) | CO2 | | |
| C15 | 4% | 3.5% | 1% | 47% | 41% | 12% | 38 | 32 |
| | 1234ze(E) | CycloC5 | CO2 | 1234ze(E) | CycloC5 | CO2 | | |
| C16 | 4% | 4% | 1% | 44% | 44% | 11% | 36.5 | 31.5 |
| | 1234ze(E) | CycloC5 | CO2 | 1234ze(E) | CycloC5 | CO2 | | |
| C17 | 4% | 1.5% | | 73% | 27% | | 42.6 | 28.6 |
| | 1234ze(E) | IsoC4 | | 1234ze(E) | IsoC4 | | | |
| C18 | 4% | 4% | | 50% | 50% | | 35 | 31 |
| | 1234ze(E) | methyl | | 1234ze(E) | methyl | | | |
| | | formate | | | formate | | | |
| C19 | 4% | 3.5% | | 53% | 47% | | 37.5 | 31.5 |
| | 1234ze(E) | methyl | | 1234ze(E) | methyl | | | |
| | | formate | | | formate | | | |
| C20 | 4% | 2.5% | | 62% | 38% | | 43.5 | 29.5 |
| | 1234ze(E) | methyl | | 1234ze(E) | methyl | | | |
| | | formate | | | formate | | | |
| C21 | 4% | 2.5% | 0.75% | 55% | 35% | 10% | 41 | 30.5 |
| | 1234ze(E) | methyl | CO2 | 1234ze(E) | methyl | CO2 | | |
| | | formate | | | formate | | | |
| C22 | 4% | 2.5% | | 73% | 27% | | 44.5 | 29 |
| | 1234ze(E) | methyl | | 1234ze(E) | DME | | | |
| | | formate | | | | | | |
| C23 | 4% | 2.5% | 0.75% | 55% | 35% | 10% | 39.5 | 29 |
| | 1234ze(E) | methyl | CO2 | 1234ze(E) | DME | CO2 | | |
| | | formate | | | | | | |

As can be seen from Table C1-C23 above, the tests used 23 different combinations of co-blowing agents, with the combinations being based on two or more of the following:
Carbon Dioxide (CO2)
Ethanol (EtOH)
1234ze(E)
1233zd(E)
Ethanol (EtOH)
Acetone
Cyclohexane (CycloC6)
Cyclopentane (CycloC5)
Isobutane (IsoC6)
methylformate
dimethylether (DME)

The results of this experimental work show, in general, that it was not possible to achieve a polystyrene foam that had a density less than about 34 kg/m3 and at the same time having an aged thermal conductivity below about 33.5 mW/mk, which is a preferred combination of density and thermal conductivity properties that is considered in desirable. The data from these 23 runs is illustrated in FIG. 2, which also illustrates that none of the produced foams was able to achieve this combination of properties (represented by the region bounded by the small-dash [symbol] arrows. More preferably in many applications, it is desirable to provide a polystyrene foam that has a density that is about 33 kg/m3 or less and at the same time an aged thermal conductivity below about 32.5 mW/mk (represented by the region bounded by the medium-dash [symbol] arrows), and all of the data above is even further from achieving this desired combination of properties. Finally, none of these foams had a density that is about 32 kg/m3 or less and at the same time an aged thermal conductivity below about 32.5 mW/mk (represented by the region bounded by the large-dash [symbol] arrows), which the most preferred set of these properties for XPS foam according to the present application.

### Comparative Examples C24-C42—XPS Foam

Additional testing was conducted in a continuing effort to determine whether any blowing agent blends existed that could produce a foam in one or more of the lower quadrants in FIG. 2. Of the additional testing performed nineteen additional blowing agents blends were not able to produce such a desired foam. The same procedure was used as describe in Comparative Examples 1-23 to produce the results reported in Table C24-C42 below.

TABLE C24-C42

| | Blowing Agent Components, pphr | | | | | | | | Blowing Agent Components, wt % of BA | | | | | | | | |
|---|---|---|---|---|---|---|---|---|---|---|---|---|---|---|---|---|---|
| Ex | ze | zd | mmz | yd | isoC4 | MF | DME | CO2 | ze | Zd | mmz | yd | IsoC4 | MF | CO2 | Den | λ_{A} |
| C24 | 4 | | | | 1.5 | | | | 72.7 | 0 | 0.0 | 0.0 | 27.3 | 0.0 | 0.0 | 42.6 | 28.6 |
| C25 | 3 | 1 | | | 2.5 | | | | 46.2 | 15.4 | 0.0 | 0.0 | 38.5 | 0.0 | 0.0 | 40.3 | 27.3 |
| C26 | 2 | | 2 | | 3 | 0.75 | | 0.25 | 25.0 | 0.0 | 25. | 0.0 | 37.5 | 9.4 | 3.1 | 38.5 | 28.6 |
| C27 | 2 | | 2 | | 3 | | | | 28.6 | 0.0 | 28.6 | 0.0 | 42.9 | 0.0 | 0.0 | 37.6 | 27.8 |
| C28 | 1.5 | | 2.5 | | 3 | 0.75 | | 0.25 | 18.8 | 0.0 | 31.3 | 0.0 | 37.5 | 9.4 | 3.1 | 37.5 | 27.7 |
| C29 | 1.5 | | 2.5 | | 2 | 1 | | 0.25 | 20.7 | 0.0 | 34.5 | 0.0 | 27.6 | 13.8 | 3.5 | 37.5 | 28.1 |
| C30 | 2 | | 2 | | 2.5 | | | | 30.8 | 0.0 | 30.8 | 0.0 | 38.5 | 0.0 | 0.0 | 38.2 | 27.4 |
| C31 | 4 | | | | 1.5 | 1 | | 0.25 | 61.6 | 0.0 | 0.0 | 0.0 | 23.1 | 15.4 | 0.0 | 36.4 | 29.2 |
| C32 | 4 | | | | | 0.75 | 1.5 | 0.25 | 61.5 | 0.0 | 0.0 | 0.0 | 0.0 | 11.5 | 3.9 | 34.8 | 30.2 |
| C33 | 3 | 1 | | | 2.5 | 0.75 | | 0.25 | 40.0 | 13.3 | 0.0 | 0.0 | 33.3 | 10.0 | 3.3 | 34 | 27.9 |
| C34 | 1 | 3 | | | 2.5 | | | | 15.4 | 46.2 | 0.0 | 0.0 | 38.5 | 0.0 | 0.0 | 34 | 28.9 |
| C35 | 2 | | | 1 | 2.5 | 1 | | 0.25 | 30.8 | 0.0 | 0.0 | 15.4 | 38.5 | 15.4 | 0.0 | 36.9 | 29.94 |
| C36 | | 1 | 3 | | 2.5 | 1 | | 0.25 | 0.0 | 12.9 | 38.7 | 0.0 | 32.3 | 12.9 | 3.2 | 35.5 | 28.5 |
| C37 | | 2 | 2 | | 3 | | | | 0.0 | 28.6 | 28.6 | 0.0 | 42.9 | 0.0 | 0.0 | 34.8 | 28.6 |
| C38 | | | 4 | | 3.5 | 0 | | | 0.0 | 0.0 | 53.3 | 0.0 | 46.7 | 0.0 | 0.0 | 38.3 | 28.1 |
| C39 | | | 1 | 3 | 3 | | | | 0 | 0.0 | 14.3 | 42.9 | 42.9 | 0.0 | 0.0 | 37.2 | 28.8 |
| C40 | | | 4 | | 3.5 | 0.75 | | 0.25 | 0.0 | 0.0 | 47.1 | 0.0 | 41.2 | 8.8 | 2.9 | 35.8 | 27.9 |
| C41 | | | 1 | 3 | 3 | 1 | | 0.25 | 0 | 0 | 12.1 | 36.4 | 36.4 | 12.1 | 3.3 | 34.7 | 29.1 |
| C42 | | | 4 | | 3.5 | 0.75 | | | 0.0 | 0.0 | 48.5 | 0.0 | 42.4 | 9.9 | 0.0 | 33.8 | 28.1 |

As can be seen from Table C24-C42 above, the tests used 19 different combinations of co-blowing agents, with the combinations being based on two or more of the following:
Carbon Dioxide (CO2)
1234ze(E) (referred to as “ze” in example tables)
1233zd(E) (referred to as “ze” in example tables)
Cis1336mzz (referred to as “mzz” in the example tables)
Cis1224yd (referred to as “yd” in the example tables)
Isobutane (referred to as “IsoC4” in the example tables)
methylformate (referred to as “MF” in the example tables)
dimethylether referred to as “DME” in the example tables)

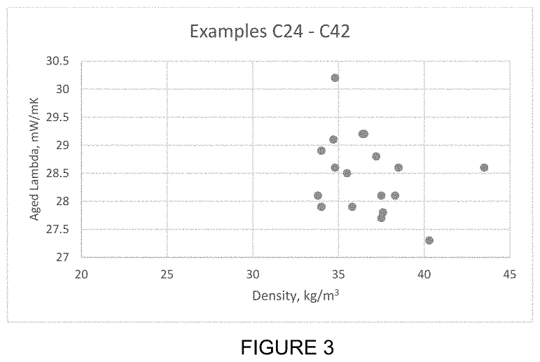

The results of this experimental work were also not able to achieve a polystyrene foam that had a density less than about 34 kg/m3 and at the same time having an aged thermal conductivity below about 33.5 mW/mk, or any other of the preferred combinations of density and thermal conductivity properties that are described herein. The data from these 19 runs is illustrated in FIG. 3.

### Examples 1—XPS Foam from Blowing Agent Consisting of 1233zd(E), 1234Ze(E), and One or More of Isobutane, Methyl Formate and CO2

A series of foam extrusion runs were conducted using the same equipment, the same operating criteria, and the same raw materials as described above in connection with the Comparative Examples, except that the blowing agents as identified in Table E1-E4 below were used and produced a foam having the properties as reported in Table E1-E4 below:

TABLE E1-E4

| | | | | | | | | Aged |
|---|---|---|---|---|---|---|---|---|
| | PPHR, | | | | | | Density | Lambda |
| Ex. | BA in | Wt % in Blowing Agent | | | | | (kg/ | (mW/ |
| No. | melt | mzz | zd | iC4 | MF | CO2 | m3) | mk) |
| E1 | 8 | 12.5 | 37.5 | 37.5 | 12.5 | 0 | 29.6 | 30.6 |
| E2 | 7.5 | 13.3 | 40 | 33.3 | 13.3 | 0 | 31.1 | 29.9 |
| E3 | 7 | 14.3 | 42.9 | 42.9 | 0 | 0 | 31.3 | 29.3 |
| E4A | 7 | 16.0 | 48 | 16 | 16 | 4 | 30.1 | 30.3 |
| E4B | 7.25 | 13.8 | 41.4 | 27.6 | 13.8 | 3.45 | 30.1 | 29.9 |

As can be seen from Table E1-E4, applicants have unexpectedly found that certain blowing agents can be formulated based on a combination of 1336mzz(Z), 1233zd(E) and isobutane, both without and with one or more of methyl formate and/or CO₂, which are able to achieve thermoplastic foams having density and aged lambda values within all three of the quadrant definitions shown in FIG. 2 and described in Comparative Example C1-C23.

### Examples 5-8—XPS Foam from Blowing Agent Consisting of 1224yd(Z) and One or More of Isobutane, Dimethyl Ether (DME), Methyl Formate (MF) and CO2

A series of foam extrusion runs were conducted using the same equipment, the same operating criteria, and the same raw materials as described above in connection with the Comparative Examples, except that the blowing agents as identified in Table E5-E8 below were used and produced a foam having the properties as reported in Table E5-E8 below:

TABLE E5-E8

| | | | | | | | | Aged |
|---|---|---|---|---|---|---|---|---|
| | PPHR, | | | | | | Density | Lambda |
| Ex. | BA in | Wt % in Blowing Agent | | | | | (kg/ | (mW/ |
| No. | melt | 1224yd | iC4 | MF | DME | CO₂ | m3) | mk) |
| E5 | 7.5 | 53.3 | 46.7 | 0 | 0 | 0 | 30.8 | 29.3 |
| E6 | 8.25 | 48.5 | 42.4 | 9.1 | 0 | 0 | 29.4 | 29.7 |
| E7 | 7.75 | 51.6 | 0 | 9.7 | 38.7 | 0 | 31.4 | 33.0 |
| E8 | 8 | 50 | 0 | 37.5 | 9.4 | 3.1 | 30.8 | 33.2 |

As can be seen from Table E5-E8, applicants have unexpectedly found that certain blowing agents based on a combination of 1224yd, isobutane and/or methyl formate, and optionally but preferably methyl formate and/or CO₂ are able to achieve thermoplastic foams having density and aged lambda values within the largest quadrant of FIG. 2, and more surprisingly Examples E5 and E6 are within even the narrowest quadrant definition shown in FIG. 2 and described in Comparative Example C1-C23.

### Examples 9-10—XPS Foam from Blowing Agent Consisting of 1224yd(Z), Isobutante (iC4), and One or More of Methyl Formate (MF) and CO₂

A series of foam extrusion runs were conducted using the same equipment, the same operating criteria, and the same raw materials as described above in connection with the Comparative Examples, except that the blowing agents as identified in Table E9-E10 below were used and except that twice the weight of talc was used. Foams having the properties as reported in Table E9-E10 below were produced:

TABLE E9-E10

| | | | | | | | Aged |
|---|---|---|---|---|---|---|---|
| | PPHR, | | | | | Density | Lambda |
| Ex. | BA in | Wt % in Blowing Agent | | | | (kg/ | (mW/ |
| No. | melt | 1224yd | iC4 | MF | CO₂ | m3) | mk) |
| E9 | 8.25 | 51.6 | 38.7 | 9.7 | 0 | 32.1 | 29.8 |
| E10 | 8 | 50 | 37.5 | 9.4 | 3.1 | 31 | 29.5 |

As can be seen from Table E9-E10, applicants have unexpectedly found that certain blowing agents based on a combination of 1224yd, isobutane and one or more of methyl formate and CO₂, are able to achieve thermoplastic foams having density and aged lambda values within about the narrowest quadrant of FIG. 2.

### Example 11—XPS Foam from Blowing Agent Consisting of 1336mzz(Z), Ethanol, and CO₂

A series of foam extrusion runs were conducted using the same equipment, the same operating criteria, and the same raw materials as described above in connection with the Comparative Examples, except that the blowing agent as identified in Table E11 below was used. Foam having the properties as reported in Table E11 below was produced:

TABLE E11

| | | | | | | Aged |
|---|---|---|---|---|---|---|
| | PPHR, | | | | Density | Lambda |
| Ex. | BA in | Wt % in Blowing Agent | | | (kg/ | (mW/ |
| No. | melt | 1336mzz(Z) | EtOH | CO₂ | m3) | mk) |
| E11 | 8.85 | 28.3 | 39.6 | 32.2 | 31.8 | 32.3 |

As can be seen from Table E11, applicants have unexpectedly found that certain blowing agents based on a combination of 1336mzz(Z), ethanol and CO₂, are able to achieve thermoplastic foams having density and aged lambda values within the narrowest quadrant of FIG. 2.

What is claimed is:

1. A method for forming extruded polystyrene foam comprising:
(a) providing a thermoplastic polystyrene melt comprising thermoplastic polystyrene and a blowing agent comprising: (i) from about 40% by weight to about 70% by weight of one or more HFOs having three or four carbon atoms and/or an HFCOs having three or four carbon atoms being selected from the group consisting of 1224yd(Z), 1233zd(E), 1336mzz(Z) and combinations of these; and (ii) from about 30% to about 60% by weight of isobutane, dimethyl ether, methyl formate, ethanol and combinations of these, provided that the amount of (i) and (ii) in the blowing agent is not less than about 90% by weight; and
(c) foaming the thermoplastic material by extruding said thermoplastic polystyrene melt to produce extruded polystyrene foam.

2. The method of claim 1 wherein the extruded polystyrene foam has a density of about 34 kg/m³ or less and an aged thermal conductivity of 33 mW/mk or less.

3. The method of claim 1 wherein the amount of (i) and (ii) in the blowing agent is not less than about 97% by weight.

4. The method of claim 1 wherein said blowing agent consisting essentially of: (i) from about 45% by weight to about 60% by weight of one or more HFOs having three or four carbon atoms and/or an HFCOs having three or four carbon atoms being selected from the group consisting of 1224yd(Z), 1233zd(E), 1336mzz(Z) and combinations of these; and (ii) from about 30% to about 55% by weight of isobutane, dimethyl ether, methyl formate and combinations of these, provided that said isobutane is present in the blowing agent in an amount of at least about 30% by weight.

5. The method of claim 1 wherein said blowing agent consisting essentially of: (i) from about 45% by weight to about 55% by weight of one or more of 1233zd(E), 1224yd(Z), 1336mzz(M) and combinations of these; and (ii) from about 45% to about 55% by weight of isobutane, dimethyl ether, methyl formate and combinations of these, provided that said methyl formate when present is present in an amount of less than about 15%; and (iii) about 3% by weight of CO₂.

6. The method of claim 1 wherein said blowing agent consisting essentially of: (i) from about 25% by weight to about 55% by weight of one or more of 1233zd(E), 1224yd(Z), 1336mzz(M) and combinations of these; and (ii) from about 25% to about 75% by weight of isobutane, dimethyl ether, methyl formate, ethanol and combinations of these, provided that said methyl formate when present is present in an amount of less than about 15%; and (iii) from about 3% to about 32% by weight of CO₂.

7. The method of claim 1 wherein said blowing agent consisting essentially of: (i) from about 45% by weight to about 55% by weight of a combination of 1233zd(E), 1224yd(Z) and 1336mzz(M); (ii) from about 40% to about 50% by weight of isobutane, methyl formate and combinations of these, provided that said methyl formate when present is present in an amount of less than about 15%.

8. The method of claim 7 wherein said blowing agent consisting essentially of: (i) from about 35% by weight to about 45% by weight of 1233zd(E); (ii) from about 10% by weight to about 15% by weight 1336mzz(Z); (iii) from about 30% to about 45% by weight of isobutane; and (iv) optionally methyl formate and optionally CO₂, provided that said methyl formate when present is present in an amount of less than about 15%.

9. The method of claim 1 wherein said blowing agent consisting essentially of: (i) from about 45% by weight to about 55% by weight of 1224yd(Z); (ii) from about 35% to about 50% by weight of isobutane, DMR and combinations of these; and (iii), optionally methyl formate and optionally CO₂, provided that said methyl formate when present is present in an amount of less than about 15%.

10. The method of claim 1 wherein said blowing agent said blowing agent consisting essentially of: (i) from about 45% by weight to about 55% by weight of 1224yd(Z); (ii) from about 35% by weight to about 40% by weight of DME; (iii) about 10% by weight of methyl formate; and (iv) optionally CO2.

11. A foam made by the method of claim 1 wherein said foam has a density of 32 kg/m³ or less and aged thermal conductivity of 31 mW/mk or less.

12. A foam made by the method of claim 1 wherein said foam has a density of 31 kg/m³ or less and aged thermal conductivity of 31 mW/mk or less.

13. A foam made by the method of claim 1 wherein said foam has a density of 31 kg/m³ or less and aged thermal conductivity of 30 mW/mk or less.

14. A foam made by the method of claim 1 wherein said foam has a density of 30 kg/m³ or less and aged thermal conductivity of 30 mW/mk or less.

15. A blowing agent for producing thermoplastic foams with excellent thermal insulating properties (including preferably low aged lambda) and low foam density, said blowing agents comprising:
(a) from about 40% by weight to about 70% by weight of one or more HFOs having three or four carbon atoms and/or an HFCOs having three or four carbon atoms being selected from the group consisting of 1224yd(Z), 1233zd(E), 1336mzz(Z) and combinations of these; and
(b) from about 30% to about 60% by weight of isobutane, dimethyl ether, methyl formate, ethanol and combinations of these, provided that the amount of (a) and (b) in the blowing agent is not less than about 90% by weight.

16. The blowing agent of claim 15 consisting essentially of:
(a) about 53% by weight of 1224yd(Z); and
(b) about 47% by weight of isobutane.

17. The blowing agent of claim 15 consisting essentially of:
(a) about 49% by weight of 1224yd(Z);
(b) about 42% by weight of isobutane; and
(c) about 9% by weight of methyl formate.

18. The blowing agent of claim 15 consisting essentially of:
(e) from about 35% by weight to about 45% by weight of 1233zd(E);
(f) from about 10% by weight to about 15% by weight 1336mzz(Z);
(g) from about 30% to about 45% by weight of isobutane; and
(h) optionally methyl formate and optionally CO₂, provided that said methyl formate when present is present in an amount of less than about 15%.

19. A method for forming extruded polystyrene foam comprising:
(a) providing a melt consisting essentially of polystyrene and a blowing agent, wherein said blowing agent consists essentially of (i) from about 40% by weight to about 70% by weight of one or more HFOs having three or four carbon atoms and/or an HFCOs having three or four carbon atoms being selected from the group consisting of 1224yd(Z), 1233zd(E), 1336mzz(Z) and combinations of these; and (ii) from about 30% to about 60% by weight of isobutane, dimethyl ether, methyl formate, ethanol and combinations of these, provided that the amount of (i) and (ii) in the blowing agent is not less than about 90% by weight, wherein the amount of said blowing agent is present in the melt in an amount of from about 5 pph to less than 10 pph;
(b) extruding the melt; and
(c) foaming the melt to form an extruded polystyrene foam having a density of from about 25 kg/m³ to less than about 34 kg/m³ and an aged thermal conductivity of from about 25 mW/mk to less than about 34 mW/mk or less.

20. The method of claim 19 wherein the extruded polystyrene foam has a density of 32 kg/m³ or less and an aged thermal conductivity of 32 mW/mk or less.
